(19) United States
(12) Patent Application Publication
(10) Pub. No.: US 2024/0405584 A1
(43) Pub. Date: Dec. 5, 2024

(54) BATTERY POWER SUPPLY CIRCUIT FOR MAXIMIZING UTILIZATION OF AVAILABLE BATTERY CAPACITY WITH A SLEEP CAPABLE LOAD

(71) Applicant: Xsense Ltd., Migdal Tefen (IL)

(72) Inventors: Andrii Isachenkov, Migdal Tefen (IL); Robert Alexander Williams, Migdal Tefen (IL)

(21) Appl. No.: 18/801,890

(22) Filed: Aug. 13, 2024

Related U.S. Application Data
(63) Continuation-in-part of application No. 18/166,519, filed on Feb. 9, 2023, now Pat. No. 12,105,547.

(51) Int. Cl. H02J 7/00

(52) U.S. Cl. CPC H02J 7/0063; H02J 7/0029; H02J 7/00712; H02J 2207/20

(57) ABSTRACT

A battery power supply (BPS) circuit to power an intermittently powered load, optimized to maximize battery capacity utilization and extend battery life, while offering low temperature performance. The BPS includes a voltage converter connected to a battery for generating a voltage greater or less than the battery voltage, a current limiter configured to limit current in a current limiting mode and to provide a shunt in a noncurrent limiting mode, a capacitor tank for providing an output voltage to the load and first charged to a voltage up to 95 or 100% (depending upon the operation of the BPS) of a desired output voltage, and second charged to the desired output voltage when the current limiter is shunted. Optionally, a relaxation/stabilization period is then applied before the load is enabled to maximize battery life. The BPS also provides a low power mode of operation while the load is disabled or in a sleep mode of operation.

### REFERENCE TO PRIORITY APPLICATION

This application is a continuation in part of U.S. patent application Ser. No. 18/166,519 filed Feb. 9, 2023, the contents of which is incorporated herein by reference in its entirety.

### FIELD OF THE INVENTION

The present disclosure relates to an apparatus and methods of powering electronic devices with batteries and more particularly relates to a battery power supply circuit for maximizing utilization of available battery capacity with a sleep capable load.

### BACKGROUND OF THE INVENTION

Many different types of electronic devices may impose particular demands on their power supplies. Lithium and lithium-ion batteries are frequently used in the power supplies of these devices. Traditional lithium-chemistry based batteries generally have a flat discharge curve and very low internal resistance. This makes them advantageous for use in applications with relatively high power requirements, such as in cellular modems, RF transceivers, IoT (Internet of Things) devices, etc., compared with batteries having non-flat discharge curves and high internal resistance, for example, alkaline batteries and other non-lithium batteries. Consequently, the latter types of batteries may have more limited utilization in electronic devices.

### SUMMARY OF THE INVENTION

A novel and useful battery power supply (BPS) circuit to power an intermittently powered load, optimized to maximize battery capacity utilization and extend battery life, while offering low temperature performance. The BPS includes a voltage downconverter connected in series to a battery and generating a voltage smaller less than the battery voltage, a current limiter connected in series to the voltage downconverter and configured to limit current from the battery when in a current limiting mode and provide a shunt in a noncurrent limiting mode, a capacitor tank connected in series to the current limiter for providing an output voltage to the load and first charged to a voltage up to either 95 or 100% (depending upon the operation of the BPS) of a desired (and final) output voltage while current limiting is on, and second charged to the desired output voltage when the current limiter is shunted.

An optional relaxation/stabilization period may then be applied before the load is enabled to maximize both battery capacity utilization and battery life. In addition, the BPS provides the ability to handle batteries with voltage greater or less than that of the output of a voltage converter by incorporating a buck-boost converter circuit. Further, the BPS provides a low power mode of operation while the load is disabled or in a sleep mode of operation.

There is thus provided in accordance with the invention, a power supply for providing battery based power to an intermittently operating load, comprising a voltage converter connected to a battery and operative to generate a desired output voltage, a current limiter connected in series to said voltage converter and operative to limit the current output thereof, a capacitor tank electrically connected to said current limiter and to the load, a controller configured to maintain an electrical disconnect between said battery and said capacitor tank when the load is disabled or in sleep mode by disabling said voltage converter via a first control signal thereby preventing battery discharge due to capacitor tank parasitic self-discharge, enable said voltage converter before the load is to be enabled or woken up whereby said capacitor tank is charged through said current limiter in a controlled manner in accordance with a first charge current surge profile to a threshold voltage less than 95% of the desired output voltage, remove current limiting via a second control signal when the voltage on the capacitor tank reaches the threshold voltage, to immediately further charge said capacitor tank to the desired output voltage in accordance with a second charge current surge profile, enable the load via a third control signal only after the second charge current surge profile is complete, disable said voltage converter when the load is to be disabled or placed in sleep mode thereby disconnecting said battery from said capacitor tank to prevent battery discharge, and wherein the threshold voltage, characteristics of the first charge current surge profile and that of the second charge current surge profile are configured to aid in maximizing both battery capacity utilization and battery life.

There is also provided in accordance with the invention, a power supply for providing battery based power to an intermittently operating load, comprising a voltage converter connected to a battery and operative to generate a desired output voltage, a current limiter connected in series to said voltage converter and operative to limit the current output thereof, a capacitor tank electrically connected to said current limiter and to the load, a controller configured to maintain an electrical disconnect between said battery and said capacitor tank when the load is disabled or in sleep mode by disabling said voltage converter via a first control signal thereby preventing battery discharge due to capacitor tank parasitic self-discharge, enable said voltage converter before the load is to be enabled or woken up whereby said capacitor tank is charged through said current limiter in a controlled manner in accordance with a first charge current surge profile to a threshold voltage less than the desired output voltage, remove current limiting via a second control signal when the voltage on the capacitor tank reaches the threshold voltage, to immediately further charge said capacitor tank to the desired output voltage in accordance with a second charge current surge profile, enable the load via a third control signal after waiting a period of time after current limiting is removed corresponding to a relaxation period associated with the battery, disable said voltage converter when the load is to be disabled or placed in sleep mode thereby disconnecting said battery from said capacitor tank to prevent battery discharge, and wherein the threshold voltage, characteristics of the first charge current surge profile and that of the second charge current surge profile are configured to aid in maximizing both battery capacity utilization and battery life.

There is further provided in accordance with the invention, a power supply for providing battery based power to an intermittently operating load, comprising a voltage converter connected to a battery and operative to generate a desired output voltage, a first voltage regulator having an input connected to the battery and an output connected via a switch to the load, a current limiter connected in series to the voltage converter and operative to limit the current output thereof, a capacitor tank electrically connected to the current limiter and to the load, a controller configured to maintain an electrical disconnect between the battery and the capacitor tank when the load is disabled or in sleep mode by disabling the voltage converter via a first control signal thereby preventing battery discharge due to capacitor tank parasitic self-discharge, power the load from the first voltage regulator while the load is disabled or in sleep mode, enable the voltage converter before the load is to be enabled or woken up whereby the voltage converter charges the capacitor tank via the current limiter, the capacitor tank charged to a threshold voltage less than 95% of the desired output voltage, remove current limiting via a second control signal when the voltage on the capacitor tank reaches the threshold voltage, to immediately further charge the capacitor tank to the desired output voltage, enable the load via a third control signal after the capacitor tank is charged to the desired output voltage, disable the voltage converter when the load is to be disabled or placed in sleep mode thereby disconnecting the battery from the capacitor tank to prevent battery discharge, and wherein the threshold voltage is configured to aid in maximizing both battery capacity utilization and battery life.

There is also provided in accordance with the invention, a power supply for providing battery based power to an intermittently operating load, comprising a voltage converter connected to a battery and operative to generate a desired output voltage, a first voltage regulator having an input connected to the battery and an output connected via a switch to the load, a current limiter connected in series to the voltage converter and operative to limit the current output thereof, a capacitor tank electrically connected to the current limiter and to the load, a controller configured to maintain an electrical disconnect between the battery and the capacitor tank when the load is disabled or in sleep mode by disabling the voltage converter via a first control signal thereby preventing battery discharge due to capacitor tank parasitic self-discharge, power the load from the first voltage regulator while the load is disabled or in sleep mode, enable the voltage converter before the load is to be enabled or woken up whereby the voltage converter charges the capacitor tank via the current limiter, the capacitor tank charged to a threshold voltage less than the desired output voltage, remove current limiting via a second control signal when the voltage on the capacitor tank reaches the threshold voltage, to immediately further charge the capacitor tank to the desired output voltage, enable the load via a third control signal after waiting a period of time after current limiting is removed corresponding to a relaxation period associated with the battery, disable the voltage converter when the load is to be disabled or placed in sleep mode thereby disconnecting the battery from the capacitor tank to prevent battery discharge, and wherein the threshold voltage is configured to aid in maximizing both battery capacity utilization and battery life.

There is further provided in accordance with the invention, a method of providing power to an intermittently operating load in a battery power supply including a voltage converter, current limiter, capacitor tank, and controller, the method comprising electrically disconnecting the battery from the capacitor tank while the load is disabled or in sleep mode by disabling the voltage converter thereby preventing battery discharge due to capacitor tank parasitic self-discharge current, enabling the voltage converter before the load is to be enabled or woken up whereby the voltage converter charges the capacitor tank via the current limiter, the capacitor tank charged to a threshold voltage less than 95% of a desired output voltage, removing current limiting when the voltage on the capacitor tank reaches the threshold voltage, to immediately further charge the capacitor tank to the desired output voltage, enabling the load after the capacitor tank is charged to the desired output voltage, and wherein the threshold voltage is configured to aid in maximizing battery capacity utilization and battery life.

There is also provided in accordance with the invention, a method of providing power to an intermittently operating load in a battery power supply including a voltage converter, current limiter, capacitor tank, and controller, the method comprising electrically disconnecting the battery from the capacitor tank while the load is disabled or in sleep mode by disabling the voltage converter thereby preventing battery discharge due to capacitor tank parasitic self-discharge current, enabling the voltage converter before the load is to be enabled or woken up whereby the voltage converter charges the capacitor tank via the current limiter, the capacitor tank charged to a threshold voltage less than a desired output voltage, removing current limiting when the voltage on the capacitor tank reaches the threshold voltage, to immediately further charge the capacitor tank to the desired output voltage, enabling the load after waiting a period of time after current limiting is removed corresponding to a relaxation period associated with the battery, and wherein the threshold voltage is configured to aid in maximizing battery capacity utilization and battery life.

There is further provided in accordance with the invention, a power supply for providing battery based power to an intermittently operating load, comprising a voltage converter connected to a battery and operative to generate a desired output voltage, a current limiter connected in series to the voltage converter and operative to limit the current output thereof, a capacitor tank electrically connected to the current limiter and to the load, and a controller configured to enable the voltage converter before the load is to be enabled or woken up whereby the capacitor tank is charged through the current limiter in accordance with a first charge current surge profile to a threshold voltage less than 95% of the desired output voltage, and wherein the threshold voltage is configured to aid in maximizing both battery capacity utilization and battery life.

There is also provided in accordance with the invention, a power supply for providing battery based power to an intermittently operating load, comprising a voltage converter connected to a battery and operative to generate a desired output voltage, a current limiter connected in series to the voltage converter and operative to limit the current output thereof, a capacitor tank electrically connected to the current limiter and to the load, a controller configured to enable the voltage converter before the load is to be enabled or woken up whereby the capacitor tank is charged through the current limiter in a controlled manner in accordance with a first charge current surge profile to a threshold voltage less than the desired output voltage, and to enable the load after waiting a period of time after current limiting is removed corresponding to a relaxation period associated with the battery, and wherein the threshold voltage is configured to aid in maximizing both battery capacity utilization and battery life.

### BRIEF DESCRIPTION OF THE DRAWINGS

The figures illustrate generally, by way of example, but not by way of limitation, various embodiments discussed in the present document. For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. References to previously presented elements are implied without necessarily further citing the drawing or description in which they appear. The number of elements shown in the figures should by no means be construed as limiting and is for illustrative purposes only.

FIG. 1 is a block diagram illustrating an example battery power supply (BPS) with a voltage downconverter for use with intermittently operating devices constructed in accordance with an embodiment of the present invention;

FIG. 2 is a graph illustrating linear characteristic of the ground current in the voltage regulator of FIG. 1;

FIG. 3 is a flow diagram illustrating an example method of operation of the BPS of FIG. 1 when powering an intermittently operating (i.e. switching) device, optionally when switching the load between an unpowered state, and a powered state, in accordance with an embodiment of the present invention;

FIG. 4 is a graph illustrating exemplary charging curve of the capacitor tank voltage in the BPS of FIG. 1 for a full off-on-off cycle, optionally when operating per the method shown in the flow chart of FIG. 3, according to an embodiment of the present invention;

FIG. 5 is a schematic diagram illustrating an example BPS, optionally an IoT system or other type of high power consumption, intermittently operating system, including a BPS, constructed in accordance with the present invention;

FIG. 6 is a diagram illustrating an oscilloscope trace of a real time measurement of voltage across the capacitor tank in the BPS of FIG. 5 in accordance with an embodiment of the present invention;

FIG. 7 is a graph illustrating the output voltage V_{OUT} curve versus time in more detail with and without a charging threshold;

FIG. 8 is a graph illustrating battery current I_{BAT} versus time for a full off-on-off cycle of the BPS;

FIG. 9 is a graph illustrating battery current I_{BAT} and output voltage V_{OUT} versus time for an example BPS of the present invention;

FIG. 10A is a graph illustrating a first example battery current profile with two controlled time spaced current pulses created by an example BPS for use with intermittently operating devices, in accordance with an embodiment of the present invention;

FIG. 10B is a graph illustrating a second example battery current profile with two controlled time spaced current pulses created by an example BPS for use with intermittently operating devices, in accordance with an embodiment of the present invention;

FIG. 10C is a graph illustrating a third example battery current profile with two controlled time spaced current pulses created by an example BPS for use with intermittently operating devices, in accordance with an embodiment of the present invention;

FIG. 11 is a block diagram illustrating an example BPS with a voltage upconverter/downconverter for use with intermittently operating devices constructed in accordance with the present invention;

FIGS. 12A and 12B are a flow diagram illustrating an example BPS method using multiple current limits (i.e. thresholds) for powering an intermittently operating (i.e. switching) device, optionally when switching the load between an unpowered state and a powered state, in accordance with an embodiment of the present invention;

FIG. 13 is a block diagram illustrating a first example BPS circuit configured for use with intermittently operating devices with a low power mode (i.e. sleep mode), constructed in accordance with an embodiment of the present invention;

FIGS. 14A and 14B are a flow diagram illustrating an example BPS method for sleep mode enabled loads, optionally when switching the load between an unpowered state, a low powered state (sleep mode), and a powered state, in accordance with an embodiment of the present invention; and

FIG. 15 is a block diagram illustrating a second example BPS circuit configured for use with intermittently operating devices with a low power mode (i.e. sleep mode), constructed in accordance with an embodiment of the present invention.

### DETAILED DESCRIPTION

Applicants have realized that use of lithium and lithium-ion batteries in IoT devices and other relatively high power consumption devices, may include a number of drawbacks as these types of batteries are hazardous, restricted in transportation and usage, and expensive. Consequently, applicants have realized that there is a need for an apparatus and for methods to power a wide class of IoT devices and other relatively high power consumption devices without degrading their critical operational characteristics, and which employ batteries such as alkaline batteries and other batteries which have widespread availability and are devoid of the disadvantages of lithium-chemistry batteries. Such an apparatus, or “battery power supply” as referred to hereinafter, in some embodiments, may be suitable for use with any type of “periodic switching” or “on and off” device or any device with different load current profiles in different states. Examples of such devices may include cellular 2G/3G/4G/5G modems, RF transceivers, and sensors, among others.

An aspect of the present invention relates to a battery power supply (BPS) including electronic circuitry configured to be connected to one or more batteries (hereinafter “battery”) possessing non-flat discharge curves and high internal resistance, optionally non-linear, and to replicate the output characteristics of a power source possessing a battery with a flat discharge curve and low internal resistance (e.g., lithium batteries, lithium-ion batteries, nickel-metal hydride (NiMH) batteries, or batteries with flat discharge curves or low internal resistance). The electronic circuitry may include analog components, digital components, and control logic configured to adjust the operating parameters of the BPS to maintain its stability over a wide temperature range, optionally when connected to intermittently operating loads. The electronic circuitry may include a voltage downconverter, pre-charging circuitry including a current limiter, storage capacitors having large-value capacitance and low output impedance, a voltage regulator, and a control unit (i.e. controller) to control the electronic circuitry thereby providing current to the intermittently operating load. Optionally, the battery and/or the load may be included in the BPS circuit. Optionally, the load may include an intermittently operating IoT device and other relatively high power switching loads. For example, an intermittently operating load may include a capacitor.

Embodiments pertain to a battery based power supply (BPS) circuit to power an intermittently operated load, optimized for battery capacity utilization and extended battery life, while also offering low temperature performance. The power supply includes one or more batteries, a voltage downconverter configured to be serially connected to a battery and to output a voltage V_{DC} smaller than a battery voltage V_{BAT}, a current limiter serially connected to the voltage downconverter and configured to limit outrush current from the battery while in a current limiting mode and to substantially provide a short circuit in a non-current limiting mode, a capacitor tank serially connected to the current limiter for providing an output voltage V_{OUT} to the load, and configured to be charged to a threshold voltage V_{TH} up to 95% of the desired V_{OUT} while the current limiter is switched to the current limiting mode, and is configured to be charged to close to V_{OUT} while the current limiter is switched to the non-current limiting mode, a control unit which measures voltages, controls the operation of the voltage downconverter and current limiter, and activates the load.

In some examples, the period of time of charging to the threshold voltage V_{TH} automatically compensates for variations in temperature and other variations in the device. This and the other features of the BPS of the present invention aid in enabling the device to operate in low temperatures.

The features of the present invention includes partial use of the current limiter, use of intermittent current draw from battery, relaxation of the battery prior to activation of the load, and the optional relaxation period between uses of the battery serve to extend battery life. Note that the term desired output voltage V_{OUT} is intended to mean the voltage output of the BPS (i.e. across the capacitor tank) that is supplied to the load device while the load is enabled and performing its function. It represents the voltage naturally present on the capacitor with the voltage converter enabled, no current limiting (i.e. shunt applied), and at steady state before the load is enabled. In other words, it is the voltage that is desired to be presented to the load before the load is enabled. It is acknowledged that V_{OUT} has several non-final values as the capacitor tank is charged during one or more current charge surge profile stages.

In alternative embodiments, the threshold voltage is not limited to 95% or less than the desired value of the output voltage but rather is less than the output of the voltage converter (i.e. less than 100% of the desired output voltage). Several applications of this alternative voltage threshold feature are described further infra.

Further, use of the term ‘predetermined’ is intended to refer to values that are predetermined (such as threshold voltage) but also refer to values that are dynamic. Applications of the mechanism of the present invention may incorporate one or more dynamically set values.

In addition, the relaxation period may or may not be included. Several applications that incorporate the relaxation period as well as several applications that exclude the relaxation period are described further infra.

In some embodiments, the electronic circuitry may include three states of operation. A first state where the load may be in unpowered mode (which may also be referred to hereinafter as “disabled”, “disabled state”, “disabled mode”, “powered off”, “off state”, “off mode”, “unpowered mode” or “unpowered state”), a second state where the load is in a relatively high-power consumption mode (which may also be referred to hereinafter as “powered mode”, “powered state”, “powered on”, “woken state”, “woken mode”, “on state”, “on mode”, “enabled state” or “enabled mode”), and a third state where the load is in a low power or sleep state (which may also be referred to hereinafter as “low power mode”, “low power state”, “sleep state” or “sleep mode”). In the first and third state, initially, the voltage converter may be set to an off mode associated with a disabled state of the converter, and the current limiter may be set to a current limiting state by the controller. In this first state, the storage capacitor (i.e. the capacitor tank) may be essentially disconnected from the battery. When the load is to be switched into the powered mode or woken up from sleep mode, the controller may first set the voltage converter to an on mode associated with an enabled state in the converter to apply an initial voltage through the current limiter on the storage capacitor to increase its charge. The controller, upon sensing the voltage on the storage capacitor and allowing for a first charging period, may disconnect the current limiter (i.e. causing a short circuit or shunting the circuit with a resistance that is less than the resistance of the circuit) to further increase the voltage on the storage capacitor and initiate a second charging period. The second charging period may be followed by an optional period of relaxation/stabilization. Following the aforementioned optional period of relaxation/stabilization, the controller may then place the load in the powered mode to draw high power current from the charged storage capacitor.

In some embodiments, the electronic circuitry may provide for protection of the battery against large current impulses and large inrush currents, and from battery drain by eliminating parasitic self-discharge currents of the storage capacitors while the load is turned off. The electronic circuitry may provide a first current surge to charge the storage capacitor(s) (i.e. capacitor tank) to a certain voltage in the process of turning on the load, followed by a gradual decrease in current when the capacitor tank is first charged. The electronic circuitry may then provide a second short current surge to the capacitor tank to bring the output voltage to the desired output voltage when current limiting is disconnected, optionally followed by a relatively long stabilization (i.e. relaxation) period (tens or hundreds of milliseconds) with a stable small (optionally milliamps range) discharge current, and then the full current when the load is powered on.

It may be appreciated that there are several advantageous features to the BPS of the present invention, in addition to serving to provide power to devices typically using batteries with flat discharge curves and a low internal resistance. The specific discharge profile formed by the first regulated surge to a first value with decreasing current, followed by a second short surge to a second value, followed by a subsequent low discharge current during stabilization, is well suited to the specific internal ion activity that is the basis of alkaline (and other) battery chemistries.

Consider an example application of the battery power supply circuit to lithium thionyl chloride (Li—SOCl2) primary cell batteries will now be described. In these batteries, electrolyte based on sulfonated thionyl chloride serves as the positive electrode. During use of these batteries, sulfation of the electrodes occurs which sharply reduces the battery's ability to deliver current. In other words, sulfation greatly increases the internal resistance of the battery. Sulfation is a time dependent, repeatable process. A sulfation layer is formed when the load is removed from the battery or subjected to a very low load current for 12 hours. To restore the battery's ability to deliver high current, this sulfation layer must be removed by applying a short, high current pulse. The second current surge of the present invention provides such a current pulse. The control unit or a microcontroller is operative to periodically apply short pulses of sulfation-breaking current to the battery. Using such a technique, the battery is desulphated automatically before the load is turned on for each power cycle of the load.

Furthermore, the BPS circuit has a fundamental feature of self-adaptation to environmental conditions, for example, to temperature variations, as well as self-adaptation to variations in component tolerances. It is noted that aluminum electrolytic capacitors with a low temperature rating of −55° C. generally exhibit a capacitance loss of between 10 and 20% when operating at −40° C. At the same time, any chemical battery exhibits a significant increase in internal resistance when operating at low temperatures. Thus, as the temperature decreases, the pre-charge current spike amplitude decreases, and consequently, the battery having increased internal resistance is less stressed.

In some embodiments, time-series data from periodical voltage measurements of the storage capacitors by the controller may be stored (e.g., in the controller) for use in a production testing stage to estimate the real capacity of the storage capacitors which may serve as an indication of the quality of the assembly, or in runtime to check its real state which may be useful and important for devices with an operational life possibly reaching or exceeding that of the electrolytic capacitors. This time-series data may be used locally by the device, or may be transmitted over communication channels from the device for use by remote services or applications. It is noted that, if the capacitance may be varied, the data may serve to adjust the capacitance accordingly.

In some embodiments, the BPS of the present invention may be integral to the device, with the battery built-in in the BPS or, alternatively, the battery may be separately replaceable. Optionally, the BPS may be a kit which may be adapted to existing devices, for example, through retrofit. It is noted that, although the BPS of the present invention is described herein as being operational with batteries possessing non-flat discharge curves and high internal resistance, optionally non-linear, the skilled person may readily appreciate that the BPS may also be used with batteries which have flat discharge curves, for example, lithium, lithium-ion batteries, and nickel-metal hydride batteries, and therefore its application is not limited to non-flat discharge curve batteries.

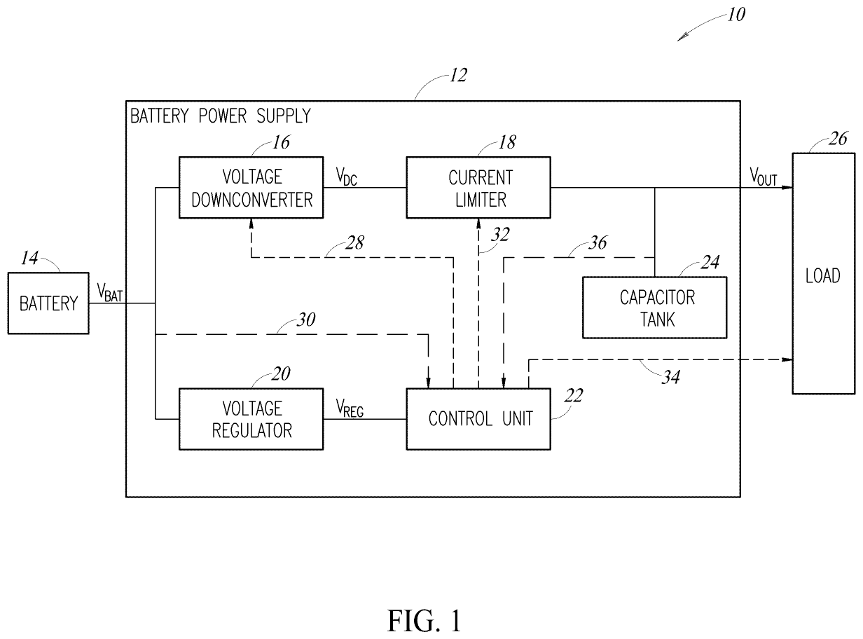

A block diagram illustrating an example battery power supply (BPS) with a voltage downconverter for use with intermittently operating devices constructed in accordance with an embodiment of the present is shown in FIG. 1. The BPS, generally referenced 10, includes a voltage downconverter 16, current limiter 18, capacitor tank 24, voltage regulator 20, control unit 22, battery 14, and load 26. The BPS is operative to supply DC power from the battery to the load. The battery has a non-flat discharge curve and a high internal resistance, generally associated with alkaline batteries and other types of non-lithium-chemistry batteries, or may have other discharge characteristics and/or other internal resistance characteristics, such as lithium or lithium-ion batteries and other types of batteries. Optionally, the load comprise an IoT device or other relatively high power consuming device generally powered by a lithium battery. Operational modes of the load may include periodic switching, optionally ON/OFF states, and/or different load current profiles in different states. The BPS comprises a voltage downconverter 16, a voltage regulator 20, a current limiter 18, a capacitor tank 24, and a control unit 22. Optionally, the battery and/or the load may be integrated within the BPS and the control unit may be external to the BPS.

The battery may include one or more batteries connected in series so that an output voltage V_{BAT} of the battery pack is generally greater than the output voltage V_{OUT} required by the load. As previously mentioned, the battery may include batteries with a non-flat discharge curve and with a relatively high internal resistance, for example, alkaline batteries, and also batteries with other discharge curve and/or other internal resistance, such as, for example, lithium metal, lithium-ion, or nickel-metal hydride (NiMH) batteries, among others. Alternatively, the battery may comprise a single battery.

The voltage downconverter may include a DC/DC converter (e.g., buck converter) which downconverts voltage V_{BAT} to V_{DC} and is configured to be turned on (i.e. enabled) and off (i.e. disabled) by the control unit, described in more detail supra. Note that V_{DC} may be of a lesser voltage than V_{BAT} and greater than or equal to V_{OUT}.

The voltage regulator 20 may include a low current voltage regulator which may output a constant voltage V_{REG} as the power source for the control unit, with V_{REG} optionally being less than, greater than or equal to V_{DC}. During “sleep” periods of the control unit, the voltage regulator output current, as an example, may be equal to or less than 10 μA. The voltage regulator may comprise a low voltage drop linear regulator with a wide input voltage range and low ground current which may be linearly dependent on the load current, optionally in the microcurrent region.

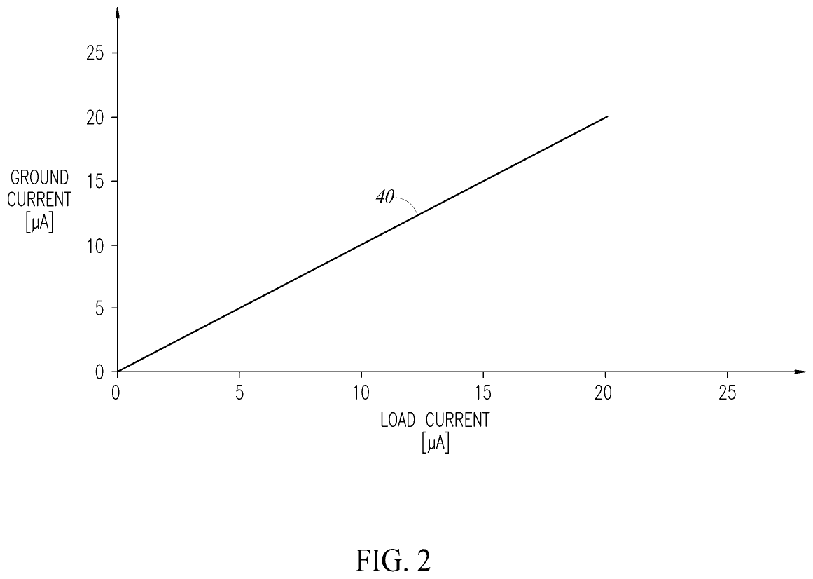

A graph showing an example linear characteristic of the ground current in the voltage regulator is shown in FIG. 2. Line 40 may vary according to the type of voltage regulator used. The graph shows ground current versus load current. The linear dependency is shown by line 40 which reflects an increase in the ground current as the load current increases. It is noted that, alternatively, the voltage regulator may include use of a switching regulator.

The current limiter may comprise any suitable type of current limiting circuit which can be controlled by the control unit to optionally either enable current limiting to a predetermined level or to disable current limiting essentially short circuiting the current limiter. The current limiter may support two or more current limiting levels. Note also that each current limiting level may exhibit either a fixed or continuously variable current limiting capability, with one of the levels optionally presenting essentially a short circuit. The current limiting predetermined level may be optionally determined by the size of the capacitor tank, the specific chemistry of the batteries used, and/or according to the implementation, and may be in the range of tens or hundreds of milliamps to several amps. The capacitor tank may comprise any type of capacitor, optionally a plurality of parallel connected capacitors, with low equivalent series resistance (ESR) and rated for voltages greater than or equal to V_{OUT}, and with a capacitance large enough for feeding relatively large, short current consumption surges demanded by the load. The load, as described infra, may comprise an IoT device or other relatively high power consuming device generally powered by, but not limited to, a lithium battery, for example, any cellular 2G/3G/4G/5G or other modem, an RF transceiver, a sensor, among others.

It is noted that the selection of the capacitor tank may be determined by the specific consumption profile of the load, and the capacity of the capacitor tank may be based on the characteristics of the battery. Protection of the battery from inrush current may be provided by the current limiter when the voltage downconverter is turned on and the capacitor tank is completely discharged. Furthermore, battery protection may be provided from the capacitor tank self-discharge current by the voltage downconverter being turned off. Therefore, use of a capacitor tank with a capacity of thousands of microfarads to farads, and self-discharge current at levels of milliamps or more, may be possible.

The control unit may be part of a device that incorporates the BPS power system or may be an integral part of the BPS. The control unit may comprise any processor based device, and may include any combination of hardware, software, and firmware. The control unit may be configured to measure V_{BAT} through monitoring signal 30, and voltage V_{OUT} across the capacitor tank through monitoring signal 36. The control unit can be configured to control operation, including enabling of voltage downconverter through control signal 28, and may additionally control operation of the current limiter through control signal 32 in order to set the current limiter to the predetermined current limiting level or to disable it. Additionally, the control unit may control operation of the load through control signal 34 in order to power the load on and off. It is noted that the monitoring signals 30 and 36, and the control signals 28, 32, and 34, may be implemented using any one, or combination of, analog and digital signals, including appropriate circuitry, including transmission buses as required.

The control unit may implement the required feedback to maintain BPS operation despite temperature variations and component tolerance variations. The control unit may also adjust operating parameters based on the type and requirements of the load, and/or battery charge level. The control unit may use monitoring signal 36 to measure V_{OUT}, and, responsively, may control the operation of the voltage downconverter and the current limiter by means of control signals 28 and 32, respectively. The control unit may use monitoring signal 30 to measure V_{BAT} and monitoring signal 36 to measure V_{OUT}, and by controlling the operation of the current limiter with control signal 32, may determine the battery charge level by indirectly measuring the internal resistance of the battery.

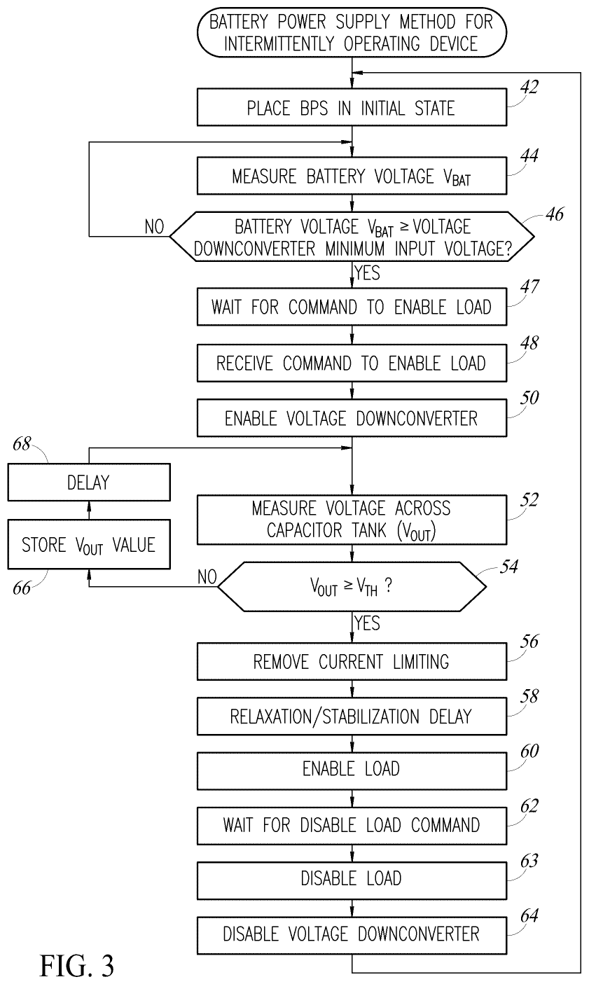

A flow diagram illustrating an example method of operation of the BPS of FIG. 1 when powering an intermittently operating (i.e. switching) device, optionally when switching the load between an unpowered state, optionally low powered, and a powered state is shown in FIG. 3. In one embodiment, the method is implemented by the control unit. With reference also to FIG. 1, the BPS is first placed in an initial state (step 42). The voltage downconverter is turned off (i.e. disabled), the current limiter is enabled and in current limiting mode at a predetermined current limiting level, the capacitor tank is discharged or in an unknown state, the voltage regulator is in an always ON state so that it is continuously operational and supplies power to the control unit, and the load is powered off.

The battery voltage V_{BAT} is measured through monitoring signal 30 (step 44) at predetermined intervals of time or continuously. It is then checked whether V_{BAT} is greater than or equal to the minimum input voltage of the voltage downconverter (i.e. if the battery voltage under light load is sufficient to start the voltage downconverter) (step 46). If it is not, the method returns to step 44. Note that troubleshooting efforts may be made to determine whether the battery is faulty or drained. If V_{BAT} is sufficiently high (step 46), the system waits for a command to enable the load (step 47). Once the command is received, the load is enabled (step 48). Note that the command may be internal or external to the BPS.

The voltage downconverter is then enabled and turned on (step 50) via control signal 28 which functions as an enable signal. Note that the voltage downconverter is enabled sufficiently in advance of the expected operation of the load, so that the capacitor tank can be sufficiently charged to power the load. On the other hand, it is not desirable to charge the capacitor tank too early where it sits idle at full charge for an excessive amount of time since during idle time, the battery is drained unnecessarily due to leakage current across the capacitor tank. The voltage downconverter functions to generate V_{DC} which is input to the current limiter. Note that the current limiter is in current limiting mode, and together with the capacity of the capacitor tank, dictates the time (i.e. delay) required to charge the capacitor tank to a threshold voltage V_{TH}. Note further that V_{TH} is a voltage up to 95% of a desired V_{OUT}. Alternatively, V_{TH} is a voltage less than 100% of a desired V_{OUT} depending on whether a relaxation time period is incorporated.

It is noted that the term threshold voltage V_{TH} is used repeatedly in descriptions of the operation of several BPS embodiments. The value of the threshold voltage in each case is not necessarily the same and can vary from one embodiment or example to another. In each case, however, the term represents the voltage at which a current surge ends, and in some cases where an additional current surge begins.

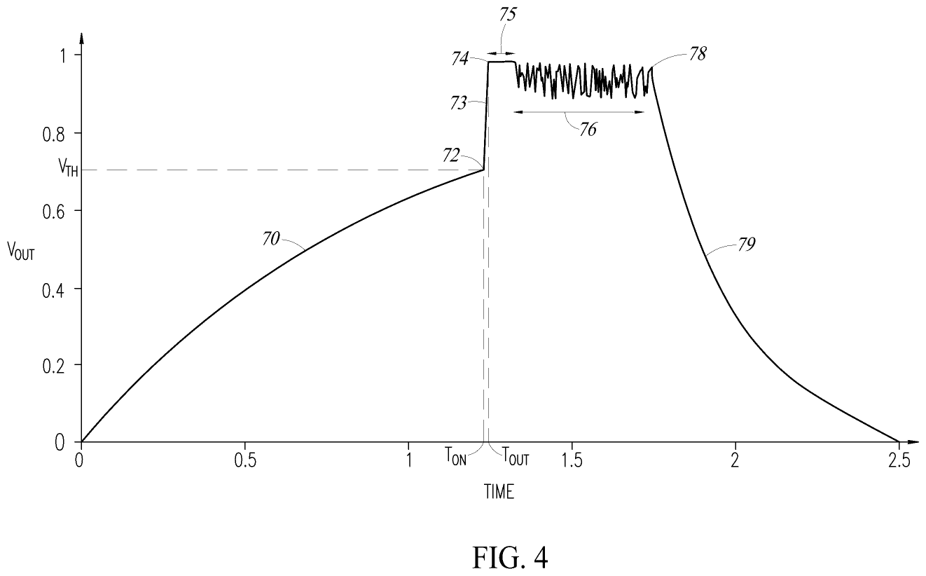

A graph illustrating exemplary charging curve of the capacitor tank voltage in the BPS of FIG. 1 for a full off-on-off cycle, optionally when operating per the method shown in the flow chart of FIG. 3 is shown in FIG. 4. It is appreciated that the following voltage relationship may be present in the BPS: V_{BAT}>=V_{DC}>=V_{TH}.

Initially, the voltage downconverter is disabled and turned off. At time zero, it is turned on and the capacitor tank begins charging with a corresponding first spike in current. The charging curve 70 represents normal exponential voltage rise while charging through the enabled current limiter. The control unit continuously or periodically measures V_{OUT} via monitoring signal 36 (step 52).

Each measurement of V_{OUT} is compared to V_{TH} (step 54) which is the expected threshold voltage value to be attained while the current limiter is enabled. V_{TH} is a value up to 95% of the desired V_{OUT}. If V_{OUT}<V_{TH} the value of V_{OUT} is optionally stored for later use in a production testing stage (step 66). A delay is then introduced (step 68) which is less than that introduced by the RC combination of the current limiting resistor and capacitor tank. The amount of the delay can be determined based on the RC time constant of the combination of the current limiter and the capacitor tank, along with an allowable error in detecting voltage equality across the capacitor tank and V_{TH}. For example, considering an error of 0.1V in performing the comparison, and based on the given RC time constant, it is known that the minimum time to charge the capacitor tank by 0.1V is Tₘᵢₙ. Therefore, the time delay can be set to Tₘᵢₙ.

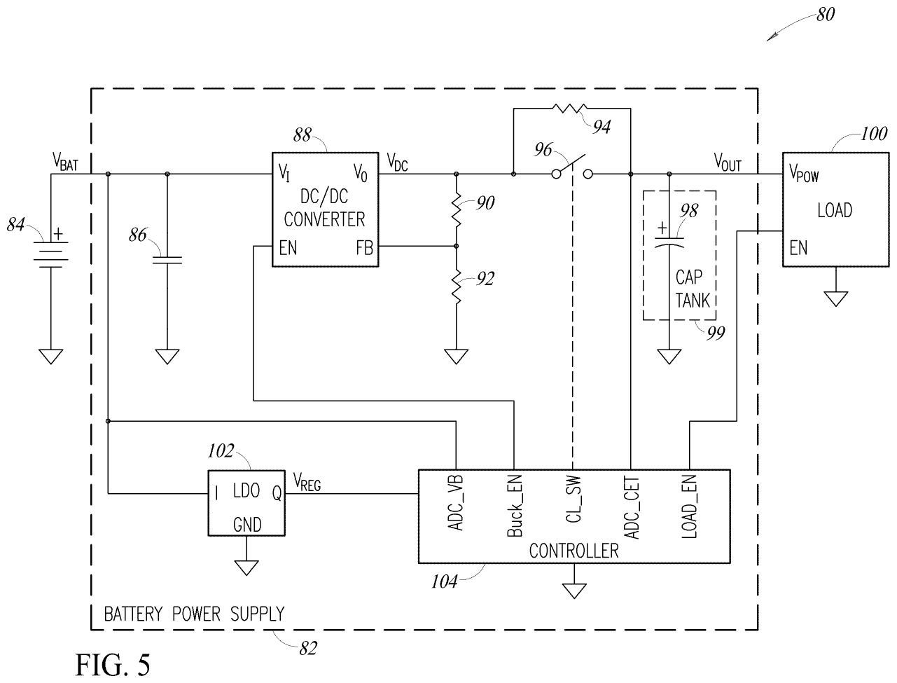

When V_{OUT}≥V_{TH} (step 54), the current limiter is removed and replaced with a short circuit (step 56). At this point (72 in FIG. 4), the specified threshold voltage relative to the output of the voltage downconverter has been reached and the shunt switch closes 96 (FIG. 5). At this point, the capacitor tank continues to charge towards the desired V_{OUT}. The voltage across the capacitor tank jumps almost instantaneously with a corresponding second spike in current (73 in FIG. 4). Note that V_{OUT} increases and approximates the desired V_{OUT} (74 in FIG. 4) which is the output of the voltage downconverter V_{DC}. It technically does not reach this voltage due to a small finite resistance remaining in any possible implementation of the current limiter despite the theoretical short circuit. Note also that it may not be necessary for capacitor tank to be fully charged at this point, and that the additional charging may be provided by the short circuit in the current limiter created by the shunt.

Following the jump in V_{OUT} after removing current limiting, a time delay is optionally introduced (75 in FIG. 4) to allow for the relaxation/stabilization of both the capacitor tank charge and the ions within the battery. In one embodiment, the value of the relaxation/stabilization delay may be tens or hundreds of milliseconds and may be optimized based on the chemistry of the particular batteries to be used in the implementation of the BPS.

Following the optional relaxation/stabilization delay, the load is turned on (i.e. enabled, powered on) (step 60). The load begins drawing current required for its operation from the charged capacitor tank and the output of the voltage downconverter (76 in FIG. 4). The load remains in the enabled state until the control unit receives a disable load command (step 62). When received, the control unit disables the load via control line 34 (78 in FIG. 4) (step 63) and turns the voltage downconverter off (step 64). Note that the control unit optionally waits for and receives an external command to disable the load. While the load is operating, it receives power from the capacitor tank. The control unit maintains the states of the control outputs while waiting for the command to deactivate the load. The method then returns to step 42 whereby the BPS is placed in the initial state again to complete the cycle.

When the capacitor tank is disconnected from the battery by disabling the voltage downconverter, it begins discharging with a relatively low discharge current (79 in FIG. 4) via a path to ground.

Note that the method of FIG. 3 may be repeated for each cycle of operation of the load from an off (unpowered) state or sleep (low power) state to an on (powered) state and back again to off. It is also noted that one skilled in the art may practice the teachings of the method described by the method of FIG. 3 using more or less steps, and/or a different sequence of steps.

Note further that during the operation of the BPS, the battery may experience a number of variable conditions. Initially, when the capacitor tank begins to charge, the battery may first see a relatively sharp surge of current, the amplitude of which may be determined by the value of the resistance in the current limiter, the real capacitance of the capacitor tank, the remaining charge in the capacitor tank (if the capacitors are not fully discharged), and the ratio of V_{BAT} to V_{DC}. The battery may experience a strong discharge current that decreases over the charging cycle with the current limiter in the current limiting mode. When the current limiter is shorted the battery may experience a second sharp surge of current. Following this second surge, the optional battery stabilization (i.e. relaxation) period is initiated. During this period, the battery discharge current may be low yet may be greater than at initialization (step 42) as it may be equal to a sum of the control unit operating current, the parasitic current drawn by the load in an off state, the self-discharge current of the capacitor tank, the current drawn by the voltage regulator in the on state, and the current drawn by the voltage downconverter.

In some embodiments, the BPS turns off the load by transferring control to a subroutine executable by the control unit. The control unit may power off the load and then disable the voltage converter in sequence without delay or with the necessary delay if the load requires it. Note that this applies regardless of the type of converter, i.e. downconverter, upconverter, buck-boost converter, etc., or whether or not the load is sleep capable. As a result, the capacitor tank may be disconnected from the battery and its leakage current does not discharge the battery.

The graph of FIG. 4 illustrates charging the capacitor tank, optionally when operating per the method of FIG. 3. The normalized voltage across the capacitor tank V_{OUT} is shown versus normalized time. The charging curve rises exponentially from V_{OUT}=0 at T=0 (70 FIG. 4) where the voltage downconverter is turned on. V_{OUT} rises to a threshold voltage V_{TH} at T=Ton, the time constant dictated by the resistance of the current limiter and the capacitance of the capacitor tank. At Ton, due to the removal of the current limiting resistor, V_{OUT} increases to approximately the desired V_{OUT} at time T=Tout with V_{OUT}=desired V_{OUT} at T=Tout.

A schematic diagram of an example BPS, optionally an IoT system or other type of relatively high power consumption, intermittently operating system is shown in FIG. 5. The system, generally referenced 80, may additionally include a non-flat discharge, high internal resistance multicell battery 84 and a connected load 100. Alternatively, the battery may include one or more batteries with flat discharge curve characteristics, for example, but not limited to lithium batteries or lithium ion batteries. Optionally, the BPS 80, battery 84, low drop out voltage regulator 102, and load 100 may be functionally similar to the BPS 10, battery 14, voltage regulator 20, and load 26 of FIG. 1, respectively.

The DC/DC converter 88 with feedback resistors R1 90 and R2 92 may comprise any well-known high speed buck DC/DC converter to implement the voltage downconverter (nonessential implementation details are omitted). R1 90 and R2 92 form an analog feedback circuit used to assess the performance of the DC/DC converter by periodic or real time (based on comparators) measurement of the feedback (FB) voltage thereof by controller 104. During normal operation of the converter 88, the feedback voltage may be equal to the voltage of the internal reference voltage source of the converter known from the manufacturer's data sheets, which may be used to check the operability of the converter 88. Note that the converter may not only serve as a voltage downconverter, but also as a controlled switch with enable/disable states controlled by the Buck_EN signal of the controller (control signal 28 in FIG. 1).

The regulator 102 may implement the voltage regulator 20 (FIG. 1) and may comprise a low dropout (LDO) regulator. Switch 96 and R_{CL} 94 together may implement the current limiter in FIG. 1. The switch may comprise any electronically controlled switch, for example, a p-type MOSFET, with a low resistance in the closed state. The switch may be controlled by signal CL_SW (control signal 32 in FIG. 1). R_{CL} 94 may comprise a current limiting resistor. In combination with the DC/DC converter and the capacitor tank 99, the current limiter circuit may form a capacitor precharge system where the converter 88 and switch 96 may form a two switch series combination. It is noted that R_{CL} 94 together with feedback resistors R1 90 and R2 92 may serve as a “bleeder” circuit for the capacitor tank 99 when the converter 88 is disabled.

The load 100 may comprise any intermittently activated load having an enable (EN) control input which turns the load on and off (load 26 in FIG. 1). The controller 104 may comprise any suitable controller to control the operation of the BPS as described supra and with reference to the operation of BPS 10 and control unit 22 in FIG. 1.

Note that Vᵢ and Vₒ of the DC/DC converter correspond to V_{BAT} and V_{DC} in FIG. 1, respectively. Additionally, I and Q in the LDO regulator 102 correspond with V_{BAT} and V_{REG} in FIG. 1, respectively. Furthermore, the ADC_CET signal corresponds to V_{OUT} in FIG. 1 and V_{POW} with V_{OUT} in FIG. 1.

The following is a description of an exemplary operation of system 80, in accordance with an example embodiment of the present invention. The description may reflect some or all of the steps shown in the flow diagram of FIG. 3. Note that initially the DC/DC regulator is in the disabled state, switch 96 is open (i.e. R_{CL} 94 provides current limiting), and the LDO regulator 102 is continuously enabled.

To turn the load on, the controller 104 first enables the DC/DC converter. Signal ADC_CET provides periodic measurements (i.e. sampling) of V_{OUT} on the capacitor tank 99 to the controller. Since the switch is in the open state, the capacitor tank is charged through R_{CL} 94. When V_{OUT} reaches a predetermined threshold V_{TH}, the controller closes the switch via the CL_SW signal thereby short circuiting R_{CL} and causing V_{OUT} to increase to its desired value. After the optional relaxation/stabilization delay (which may be optional depending on the implementation), the controller activates LOAD_EN to enable the load.

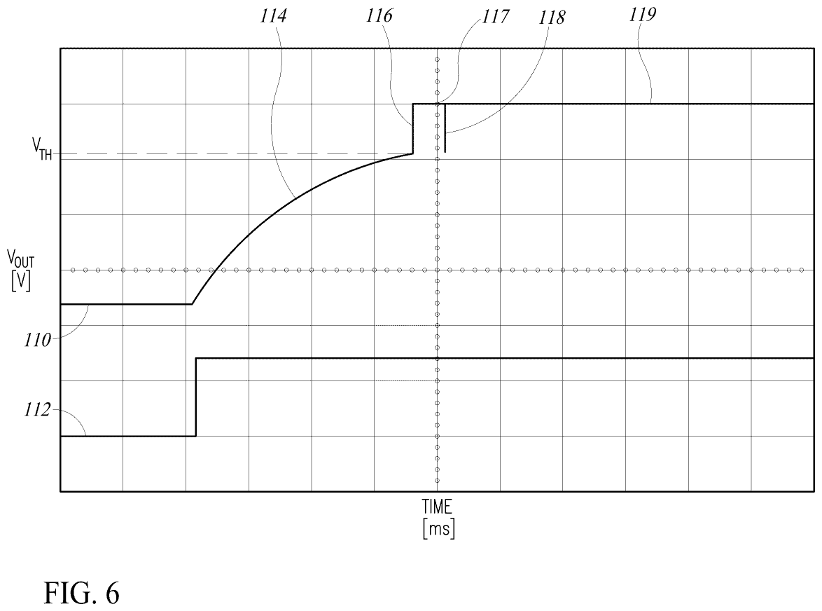

A graph illustrating a real time measurement of V_{OUT} (upper) and the Buck_EN control signal (lower) is shown in FIG. 6. V_{OUT} is at zero during 110 while the voltage downconverter is off. Once it is turned on, the capacitor begins charging in 114. Once the threshold voltage V_{TH} is reached, the current limiter is short circuited and V_{OUT} spikes 116 to raise the voltage to the desired output value. An optional short battery relaxation/stabilization period 117 follows until the load is enabled. This time interval lies between the controllable inrush battery current spike 116 and the voltage drop 118. The short negative voltage drop 118 across the capacitor tank occurs due to the load being turned on by the LOAD_EN signal. For the remainder of the trace 119 power is supplied to the load.

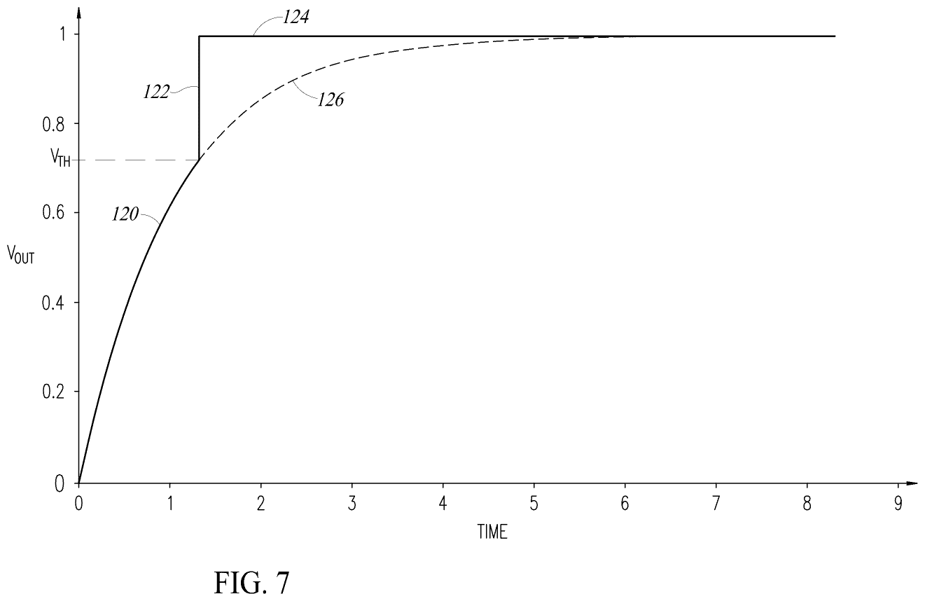

A graph illustrating normalized output voltage V_{OUT} curve versus normalized time in more detail with and without a charging threshold is shown in FIG. 7. The solid curve represents the output voltage on the capacitor tank with the threshold. The capacitor tank charges initially from zero through the current limiter and continues until the charging threshold V_{TH} is reached (120). As described supra, this threshold can vary up to 95% of the desired output voltage. At the point in time when the current limiter is removed (i.e. shorted), the voltage rises instantaneously (122) to the desired output voltage. After an optional relaxation time period, the load is enabled and the output voltage is relatively stable (124).

Note that in general, if a BPS embodiment includes a relaxation period, then the threshold voltage is less than 100% of the desired output voltage. If the BPS embodiment does not include a relaxation period, than the threshold voltage is up to 95% of the desired output voltage. This applies regardless of the type of converter, i.e. downconverter, upconverter, buck-boost converter, etc., or whether the load is sleep capable or not.

If no charge threshold is employed, the capacitor tank continues charging through the current limiter and the resulting voltage rises along the dashed curve (126) until reaching the desired output voltage. Without the benefit of the mechanism of the present invention, however, maximum battery capacity utilization and maximum battery life is not achieved.

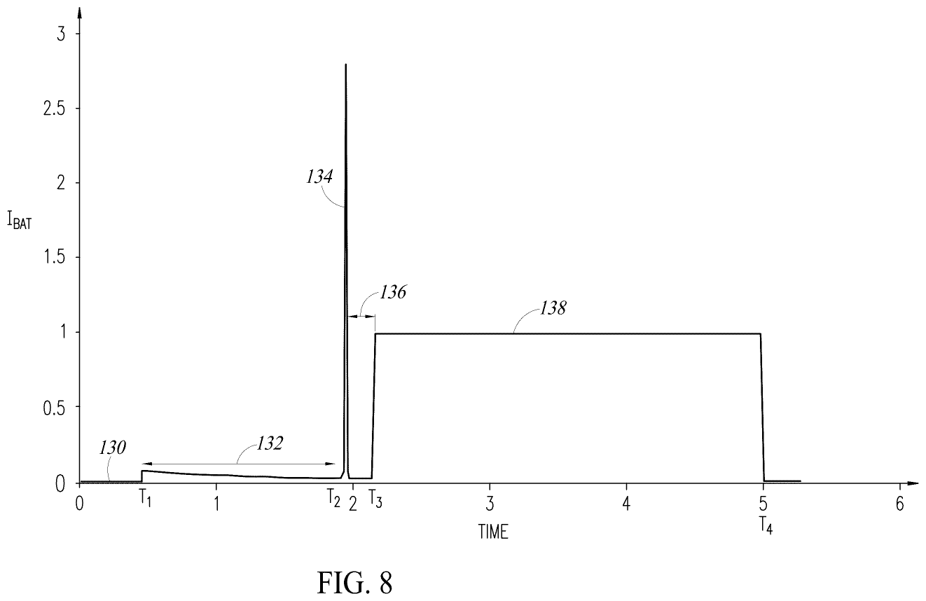

A graph illustrating normalized battery current I_{BAT} versus normalized time for a full off-on-off cycle of the BPS is shown in FIG. 8. Initially, the BPS is not providing power to the load and the battery current is minimal (130), e.g., sub milliamp, and the capacitor tank is discharged. At time T₁ the BPS receives a command to power the load and the voltage downconverter is enabled. Current from the battery begins charging the capacitor tank via the current limiter in a first current surge. This results in an almost instantaneous rise in battery current through the current limiter as shown. Battery current then decreases in accordance with the RC time constant with a resulting increase in capacitor tank voltage V_{OUT} (132). At time T₂ the voltage across the capacitor tank reaches the predetermined threshold V_{TH} and the current limiter is disabled (i.e. shunt switch is closed). A second current surge occurs due to low output impedance of the voltage downconverter (134). A battery relaxation/stabilization period 136 follows until the load is enabled at T₃ and battery current rises sharply to the level to meet the power requirements of the load (138).

Note that the value of the first battery current surge at T₁ and the value of second battery current surge at T₂ may each be individually controllable and are not necessarily equal whereby the specific values of these current surges can be determined experimentally to optimize the operation of the entire BPS. It is additionally noted that the relaxation time interval 136 is controllable. Time interval 132 is dependent on the capacity of the capacitor tank such that battery current I_{BAT} is not dependent thereon. The peak of second current surge 134 is not necessarily dependent upon the size of the capacitor tank, but rather on the function and values of the other components of the BPS. The relaxation time interval 136 relates to the process of relaxation (i.e. stabilization) of charge carriers (i.e. ions) within the battery but also may relate to the process of voltage stabilization on the capacitor tank because this time interval is much longer than the duration of the second current surge and is typically measured in tens or hundreds of milliseconds corresponding to the mobility of battery's charge carrier chemistry makeup. At some point, after the load is enabled, the system receives a command to turn the load off. At time T₄ the load is disabled and I_{BAT} returns to its initial state.

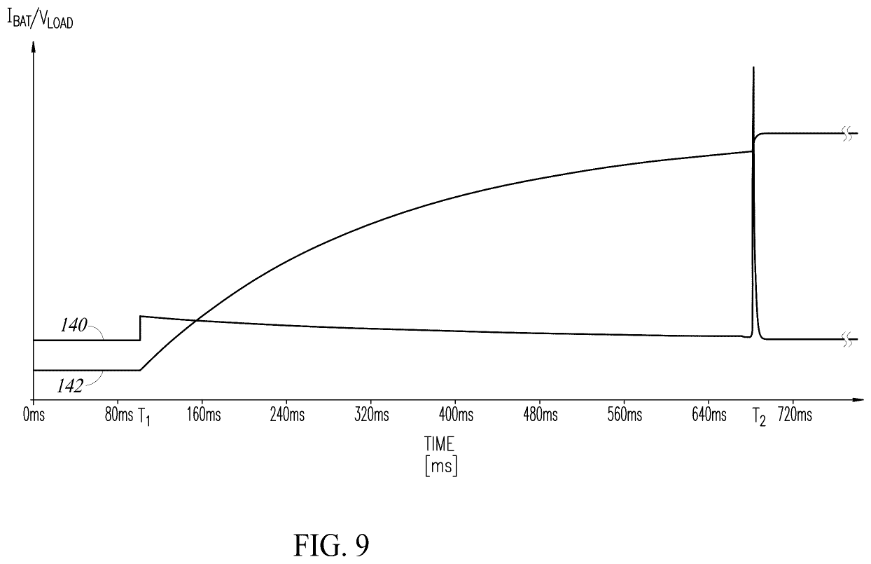

A graph illustrating battery current I_{BAT} 140 and output voltage V_{OUT} 142 versus time for an example BPS of the present invention is shown in FIG. 9. Note that curve 140 is a portion of the battery current curve of FIG. 8 shown over a wider time scale with the output voltage curve 142 overlaid over it. As described supra, at time T₁, the voltage downconverter is enabled and current from the battery begins to charge the capacitor tank through the current limiter. This continues until time T₂ when the voltage threshold is reached. At that point, the current limiter is shunted and a spike in current instantaneously raises the voltage across the capacitor tank.

In an alternative embodiment, the BPS described supra is modified to include a voltage upconverter or both a voltage downconverter and upconverter, e.g., a buck-boost converter. The modification is based on the realization that the behavior of I_{BAT} may be controlled to allow for the use of any type of battery source regardless of whether the battery source voltage is greater than, equal to, or less than the voltage required by the load.

Controlling the battery discharge may include creating a battery current profile with two time spaced current pulses whose amplitudes are controlled, and where the time spacing between the current pulses is an automatically generated delay based on the real-time capacitance of the capacitor tank. This may be particularly advantageous as it not only allows the BPS to be used with any type of battery source independent of load voltage requirements, but may provide for BPS operation that is not substantially affected by changes in the parameters of the capacitor tank (i.e. due to environmental conditions including temperature) nor by aging of components.

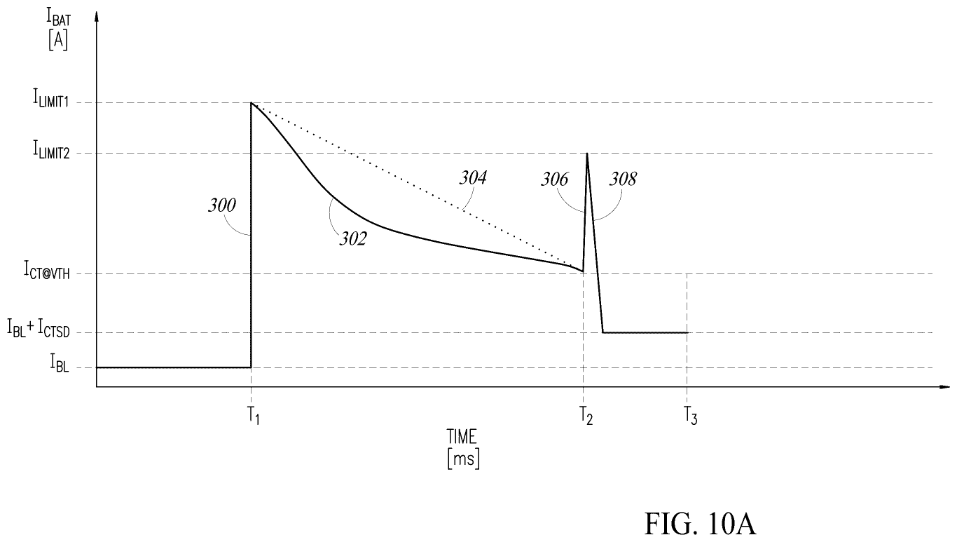

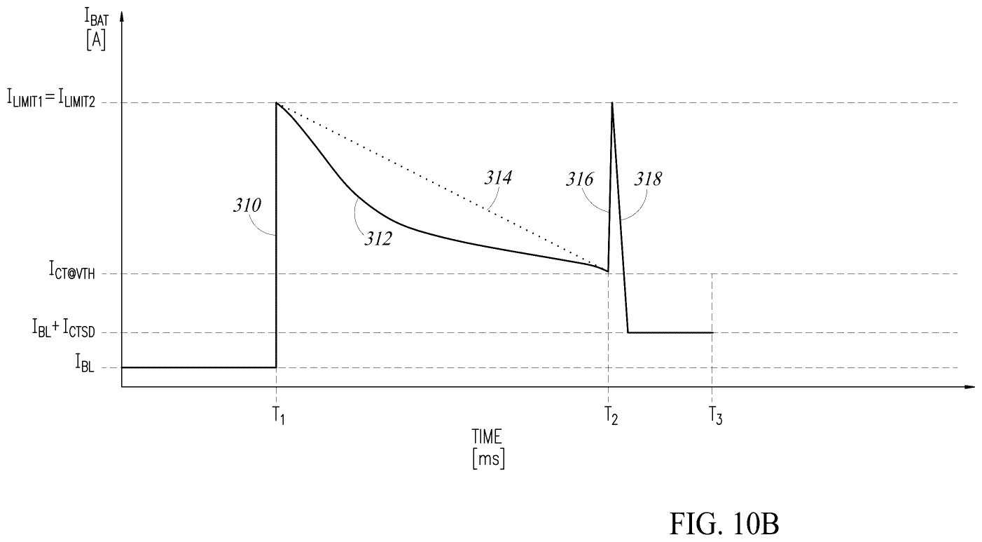

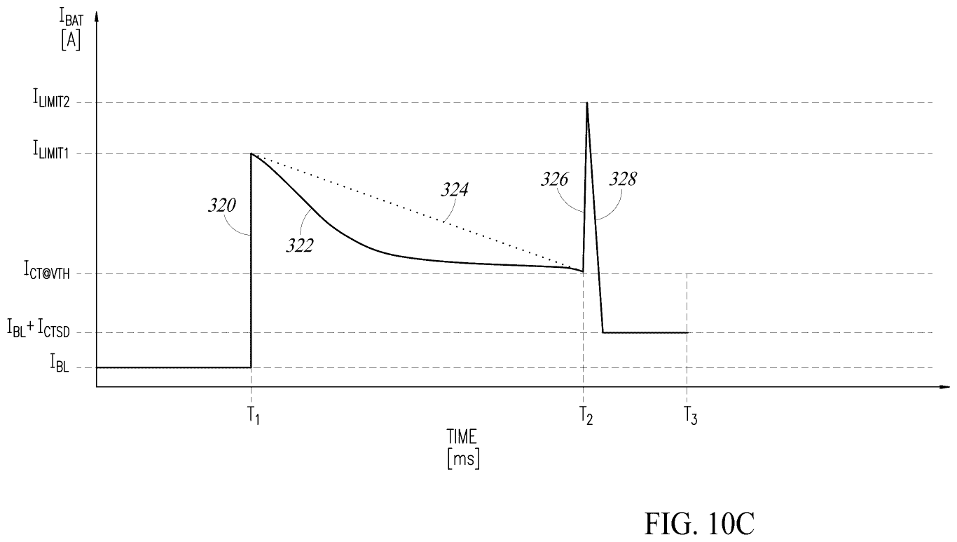

A graph illustrating a first example battery current profile with two controlled time spaced current pulses created by an example BPS for use with intermittently operating devices, in accordance with an embodiment of the present invention is shown in FIG. 10A. At time T<T₁ the BPS is in a baseline state (typically sub milliamp) (i.e. disabled or in sleep mode) with the load in either the off or sleep state where I_{BAT} is substantially equal to zero other than minimal current I_{BL} required to power the voltage regulator and the control unit. The capacitor tank is in the discharged state and V_{OUT} is zero. At time T₁, the voltage converter 154 is enabled and inrush current flows to the capacitor tank, shown by an almost instantaneous rise 300 in I_{BAT} to the predetermined value I_{LIMIT1}. I_{BAT} then decreases exponentially 302 (or linearly 304 or by any physically implementable curve) in accordance with the increase in V_{OUT} across the capacitor tank until it reaches a predetermined threshold voltage V_{TH} up to 95% of the desired V_{OUT} at time T=T₂. Note that the battery discharge current I_{CT@VTH} at time T₂ is determined by the initial charge of the capacitor tank, its real electrical capacity and voltage V_{TH}.

At time T=T₂, the current limiter is configured to permit a predetermined value I_{LIMIT2} creating a second almost instantaneous spike 306 in I_{BAT} to charge the capacitor tank to substantially the desired V_{OUT}. This is followed by an exponential (or linear or any physically implementable curve) decline 308 in I_{BAT} as the capacitor tank reaches full charge where the decline can be extremely rapid or extended in time. The decline in the battery discharge current is complete when the current reaches level I_{BL}+I_{CTSD}, which is determined by the sum of the currents I_{BL} and capacitance tank self-discharge I_{CTSD} currents.

The battery discharge current I_{BL}+I_{CTSD} may be maintained for some time until time T₃ to ‘calm’ transient chemical processes and restore normal operating voltage. This period of time is referred to as the battery relaxation period.

A graph illustrating a second example battery current profile with two controlled time spaced current pulses created by an example BPS for use with intermittently operating devices, in accordance with an embodiment of the present invention is shown in FIG. 10B. At time T<T₁ the BPS is in a baseline state (typically sub milliamp) (i.e. disabled or in sleep mode) with the load in either the off or sleep state where I_{BAT} is substantially equal to zero other than minimal current I_{BL} required to power the voltage regulator and the control unit. The capacitor tank is in the discharged state and V_{OUT} is zero. At time T₁, the voltage converter 154 is enabled and inrush current flows to the capacitor tank, shown by an almost instantaneous rise 310 in I_{BAT} to the predetermined value I_{LIMIT1}. I_{BAT} then decreases exponentially 312 (or linearly 314 or by any physically implementable curve) in accordance with the increase in V_{OUT} across the capacitor tank until it reaches a predetermined threshold voltage V_{TH} up to 95% of the desired V_{OUT} at time T=T₂. Note that the battery discharge current I_{CT@VTH} at time T₂ is determined by the initial charge of the capacitor tank, its real electrical capacity and voltage V_{TH}.

At time T=T₂, the current limiter is configured to permit a predetermined value I_{LIMIT2} creating a second almost instantaneous spike 316 in I_{BAT} to charge the capacitor tank to substantially the desired V_{OUT}. This is followed by an exponential (or linear or any physically implementable curve) decline 318 in I_{BAT} as the capacitor tank reaches full charge where the decline can be extremely rapid or extended in time. The decline in the battery discharge current is complete when the current reaches level I_{BL}+I_{CTSD}, which is determined by the sum of the currents I_{BL} and capacitance tank self-discharge I_{CTSD} currents.

The battery may discharge current I_{BL}+I_{CTSD} may be maintained for some time until time T₃ to ‘calm’ transient chemical processes and restore normal operating voltage. This period of time is referred to as the battery relaxation period.

A graph illustrating a third example battery current profile with two controlled time spaced current pulses created by an example BPS for use with intermittently operating devices, in accordance with an embodiment of the present invention is shown in FIG. 10C. At time T<T₁ the BPS is in a baseline state (typically sub milliamp) (i.e. disabled or in sleep mode) with the load in either the off or sleep state where I_{BAT} is substantially equal to zero other than minimal current I_{BL} required to power the voltage regulator and the control unit. The capacitor tank is in the discharged state and V_{OUT} is zero. At time T₁, the voltage converter 154 is enabled and inrush current flows to the capacitor tank, shown by an almost instantaneous rise 320 in I_{BAT} to the predetermined value I_{LIMIT1}. I_{BAT} then decreases exponentially 322 (or linearly 324 or by any physically implementable curve) in accordance with the increase in V_{OUT} across the capacitor tank until it reaches a predetermined threshold voltage V_{TH} up to 95% of the desired V_{OUT} at time T=T₂. Note that the battery discharge current I_{CT@VTH} at time T₂ is determined by the initial charge of the capacitor tank, its real electrical capacity and voltage V_{TH}.

At time T=T₂, the current limiter is configured to permit a predetermined value I_{LIMIT2} creating a second almost instantaneous spike 326 in I_{BAT} to charge the capacitor tank to substantially the desired V_{OUT}. This is followed by an exponential (or linear or any physically implementable curve) decline 328 in I_{BAT} as the capacitor tank reaches full charge where the decline can be extremely rapid or extended in time. The decline in the battery discharge current is complete when the current reaches level I_{BL}+I_{CTSD}, which is determined by the sum of the currents I_{BL} and capacitance tank self-discharge I_{CTSD} currents.

The battery may discharge current I_{BL}+I_{CTSD} may be maintained for some time until time T₃ to ‘calm’ transient chemical processes and restore normal operating voltage. This period of time is referred to as the battery relaxation period.

Thus, the amplitude of the battery discharge current surges I_{LIMIT1} and I_{LIMIT2} can be set to have any ratio, i.e. I_{LIMIT1}>L_{LIMIT2} (FIG. 10A), I_{LIMIT1}=I_{LIMIT2} (FIG. 10B), and I_{LIMIT1}<I_{LIMIT2} (FIG. 10C). The ratio of these amplitudes can be set statically at the BPS circuit design stage or dynamically during operation of the BPS circuit. Note that the values of I_{LIMIT1} and I_{LIMIT2} are typically not constants. In addition, in one embodiment, the values of I_{LIMIT1} and I_{LIMIT2} may be determined by varying the voltage threshold.

As described supra, the BPS can be modified to allow operation with batteries having a voltage greater than, equal to, or less than the voltage required by the load. This may be achieved by controlling the behavior of the battery current profile to include two time spaced current pulses with controlled amplitudes with a time delay between the pulses generated automatically based on the size of the capacitor tank. Note that alternatively more than two spaced current pulses may be applied depending on the particular implementation.

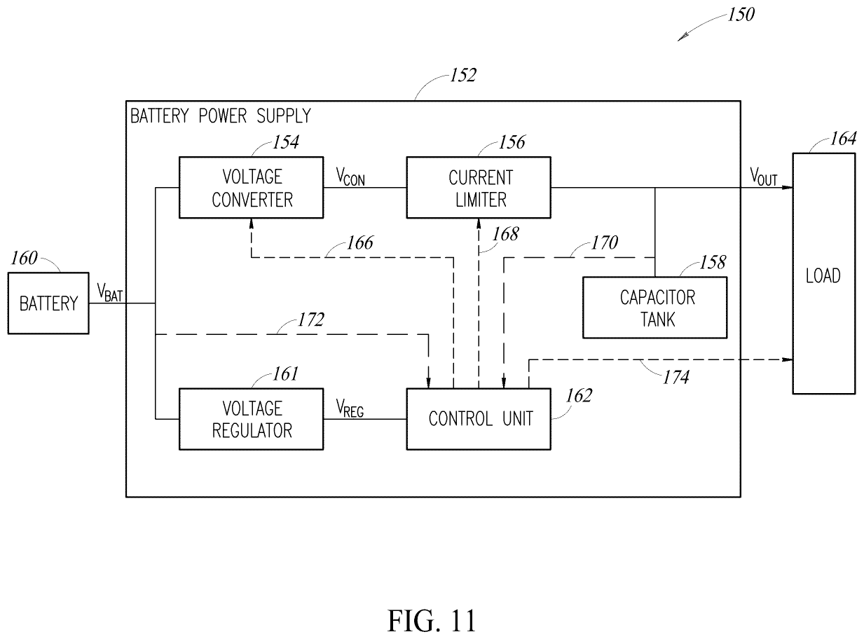

An example of a correspondingly modified BPS incorporating a voltage upconverter/downconverter for use with intermittently operating devices is shown in FIG. 11. In one embodiment, BPS 150 is constructed similarly to that of FIG. 1 and comprises a voltage converter 154, voltage regulator 161, current limiter 156, capacitor tank 158, and control unit 162. The BPS is configured to supply dc power from a battery 160 to a load 164. The battery voltage V_{BAT} may be greater than, less than, or equal to the desired V_{OUT} required by the load.

The voltage output V_{CON} of the converter 154 functions to convert V_{BAT} to V_{CON} which is close to the output voltage V_{OUT}. The voltage converter is configured to be turned on (enabled) and off (disabled) by the control unit 162. The converter may comprise a downconverter (e.g., buck converter) when V_{BAT} is greater than V_{OUT} and/or may comprise an upconverter when V_{BAT} is less than V_{OUT}. Optionally, the converter comprises a buck-boost converter capable of automatically switching between a boost mode and a buck mode depending on the load voltage required. Note that the converter may provide a voltage V_{CON} substantially equal to V_{BAT} within a substantially “equal” range to the required V_{OUT}.

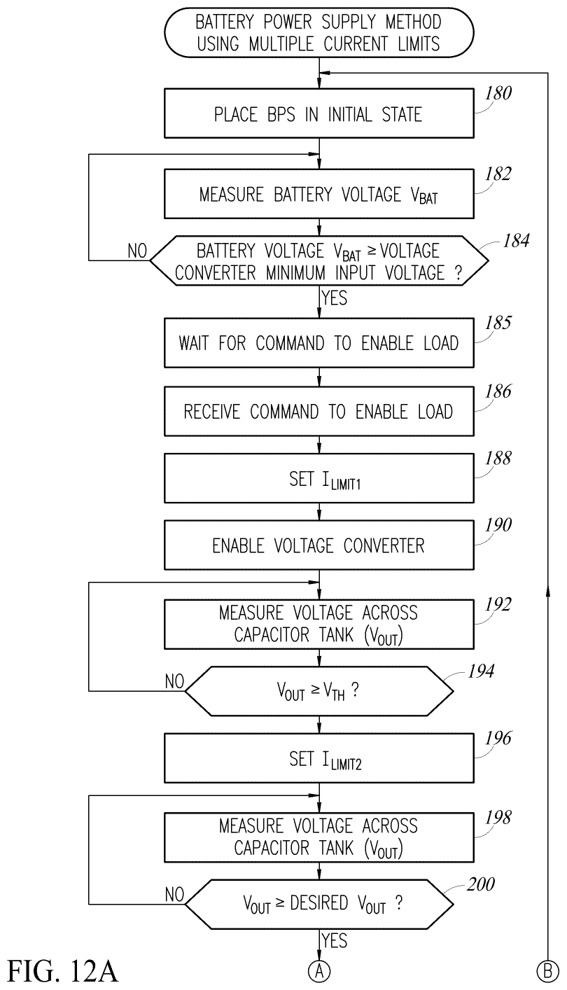

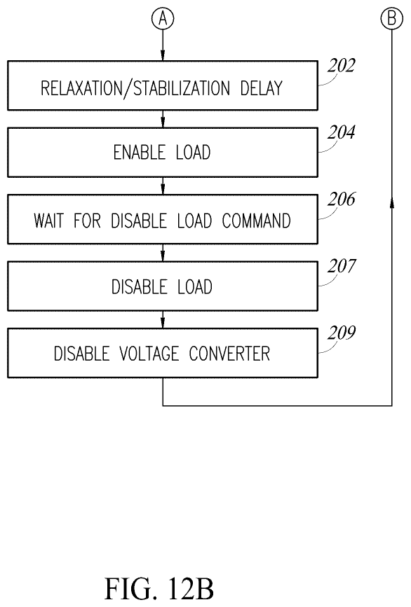

In one embodiment, the voltage regulator 160 is functionally similar to that of FIG. 1 and configured to supply power to the control unit which functions to control the components in the BPS according to programmed instructions, and as required to perform the method described in FIGS. 12A and 12B associated with the operation of the BPS. The capacitor tank may be functionally similar to that of FIG. 1 such that V_{OUT} is charged to the desired output voltage.

The current limiter may comprise any suitable controllable current limiter configured to be switched between two or more current limit levels (e.g., I_{LIMIT1} and I_{LIMIT2}). The values of the two current limits may be determined by the chemistry and capacity of the particular battery used and may be in the range from tens to hundreds of milliamps to several amps. The current limiter may include a discharge path to provide automatic discharge of the capacitor tank when the load is turned off.

Control signals 166, 168, and 174 may be functionally similar to control signals 28, 32, and 34 (FIG. 1), respectively. Monitoring signals 172 and 170 may be functionally similar to monitoring signals 30 and 36, respectively.

A flow diagram illustrating an example BPS method using multiple current limits (i.e. thresholds) for powering an intermittently operating (i.e. switching) device, optionally when switching the load between an unpowered or low powered state, and a powered state, in accordance with an embodiment of the present invention is shown in FIGS. 12A and 12B. This method is normally performed by the control unit 162 for providing intermittent power from the battery to the load.

Initially, the BPS is placed in an initial state (step 180) where the voltage converter is disabled, the voltage regulator is in an always on state to continuously supply power to the control unit, the capacitor tank is discharged (V_{OUT}=0), and the load is in an unpowered state.

The control unit measures the battery voltage V_{BAT} through monitoring signal 172 (step 182). The control unit is configured to measure V_{BAT} at predetermined intervals of time or continuously. If V_{BAT} does not exceed a minimum input voltage required by the voltage converter (step 184), the method returns to step 182 to check whether the battery is faulty or drained. If it does exceed the minimum required input voltage (i.e. the battery voltage under light load is sufficient to start the voltage converter), the control unit waits for a command to enable the load (step 185). Once the command to enable the load (step 186) is received, the control unit in response sets the current limiter to I_{LIMIT1} via control signal 168 (step 188).

The control unit then enables the voltage converter via control signal 166 which may function as an enable signal (step 190). Note that the voltage converter may comprise a boost converter, buck converter, or a buck-boost converter, depending on the voltage output of the battery and the load requirements. With reference to FIG. 10A for example, turning on the voltage converter causes the capacitor tank to begin charging to a threshold voltage V_{TH} up to 95% of the desired V_{OUT}, the rate of charge being limited by the selection of I_{LIMIT1} in the current limiter. Limiting the inrush battery current limits the charging of the capacitor tank. The inrush I_{BAT} charging the capacitor tank is represented by an almost instantaneous rise 300 in I_{BAT} to bring the voltage across the capacitor tank to the output voltage of the voltage converter.

The control unit measures V_{OUT} via monitoring signal 170 either continuously or periodically with a period that is significantly less than the time required to fully charge the capacitor tank at the selected level of charging current (e.g., 50 to 100 times less, or significantly less than the time constant of the capacitor charging circuit) (step 192).

The control unit compares each V_{OUT} measurement to a predetermined threshold voltage V_{TH} which is the expected voltage to be reached while the current limiter is set to I_{LIMIT1}. If V_{OUT}<V_{TH} (step 194) the method returns to step 192. If V_{OUT}≥V_{TH}, the control unit configures I_{LIMIT2} in the current limiter via control signal 168 (step 196). V_{OUT} increases and reaches its desired value, notwithstanding resistance in both current limiting modes of the current limiter. The capacitor tank is fully charged at this point and the additional charging provided by the surge current is due to the change in the current limiting levels in the current limiter from I_{LIMIT1} to I_{LIMIT2}.

Note that because the capacitor tank is charged to a voltage V_{TH} less than the desired V_{OUT}, the moment the current limiter switches from I_{LIMIT1} to I_{LIMIT2}, a large current is drawn. This results in a burst of current (306 in FIG. 10A) which fully charges the capacitor tank. The amplitude of the current spike may be determined by the charge value of the capacitor tank at that point in time. In turn, the charging of the capacitor tank is determined by the value of the threshold voltage V_{TH} as well as the amplitude of the second controlled current pulse.

The control unit measures V_{OUT} (step 198) to determine if it has reached the desired V_{OUT} via monitoring signal 170 (step 200). If it has not, the method returns to step 198. The capacitor tank continues to charge with V_{OUT} increasing as a result of I_{BAT}, which exponentially decreases as shown by exponential decay 308, 318, 328 (FIGS. 10A, 10B, 10C, respectively). If it has, in response to the expected jump in V_{OUT} following the setting of I_{LIMIT2}, the control unit implements a delay to allow for the stabilization (i.e. relaxation) of both V_{OUT} and the ions of the battery (step 202). In practical implementations, the value of the stabilization delay may be tens to hundreds of milliseconds, and may be optimized based on experiments using batteries of the required chemistry.

Following the stabilization delay, the control unit enables the load via control signal 174 (step 204). V_{OUT} is applied to the load which then draws current required for operation from the charged capacitor tank and the output of the voltage converter. The load remains enabled until the control unit is instructed to turn the load off.

At a point in time, the control unit receives an external command to disable the load (step 206). Once received, the controller disables the load via control line 174 (step 207) and disables the voltage converter via control line 166. Once the voltage converter is disabled, the capacitor tank discharges through the current limiter and DC/DC converter set resistors 90, 92. The control unit maintains the states of the control outputs while waiting to receive the external command to deactivate the load. Note that turning off the load may be initiated by transferring control to a subroutine executable by the control unit. The control unit can power off the load and then disable the voltage converter in sequence without delay or with a delay if the load requires it. As a result, the capacitor tank is disconnected from the battery due the voltage converter being disabled. The method then returns to the state of the BPS in its initial state (step 180).

Note that the method of FIGS. 12A and 12B may be repeated for every operation which requires switching the operation of the load between an unpowered and a powered state. Note also that one skilled in the art may implement the method using more or less steps, and/or a different sequence of steps.

Note further that not all intermittent operating devices are always powered on and off, and that some may have a sleep mode where very low power is consumed by the device instead of having to be completely powered off. In some embodiments, the BPS described in FIG. 11 can be modified to operate with intermittently operating devices which operate with sleep modes.

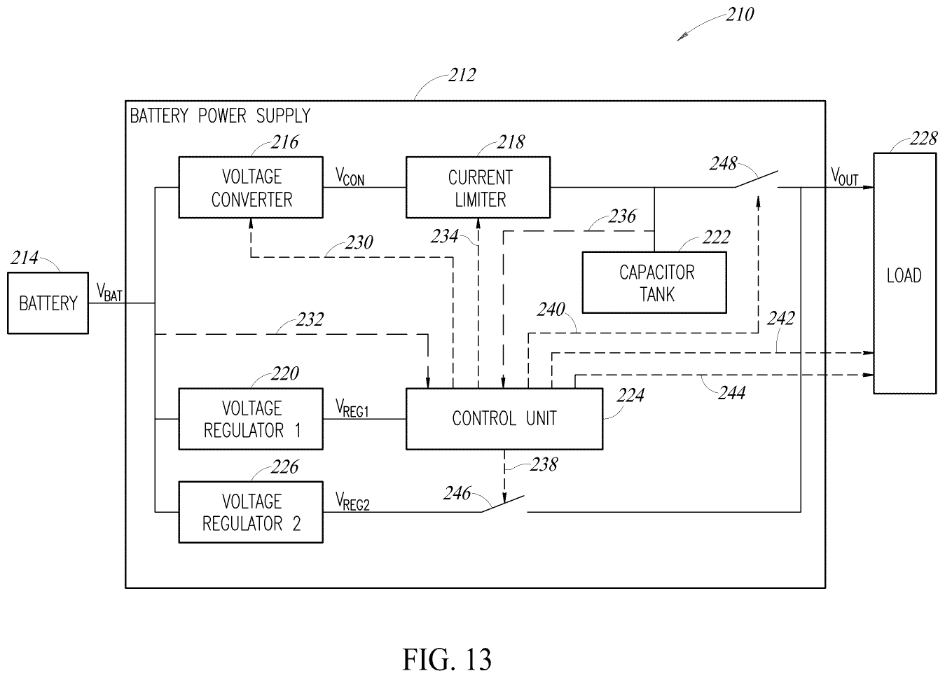

A block diagram illustrating a first example BPS circuit configured for use with intermittently operating devices with a low power mode (i.e. sleep mode), constructed in accordance with an embodiment of the present invention is shown in FIG. 13. The BPS, generally referenced 210, is similar to the BPS 150 (FIG. 11) with the exception of being configured to provide DC power from the battery 214 to the load 228 where the load is configured to be switched between a high power operational mode and a low power sleep mode, in addition to, or alternative to, an off mode where the load is completely turned off.

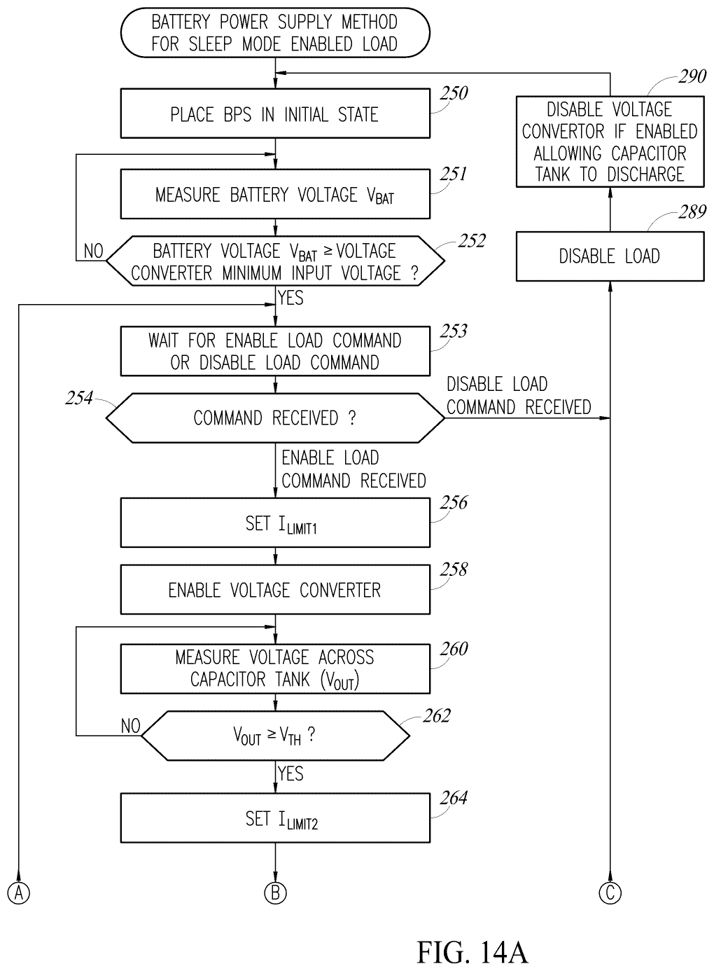

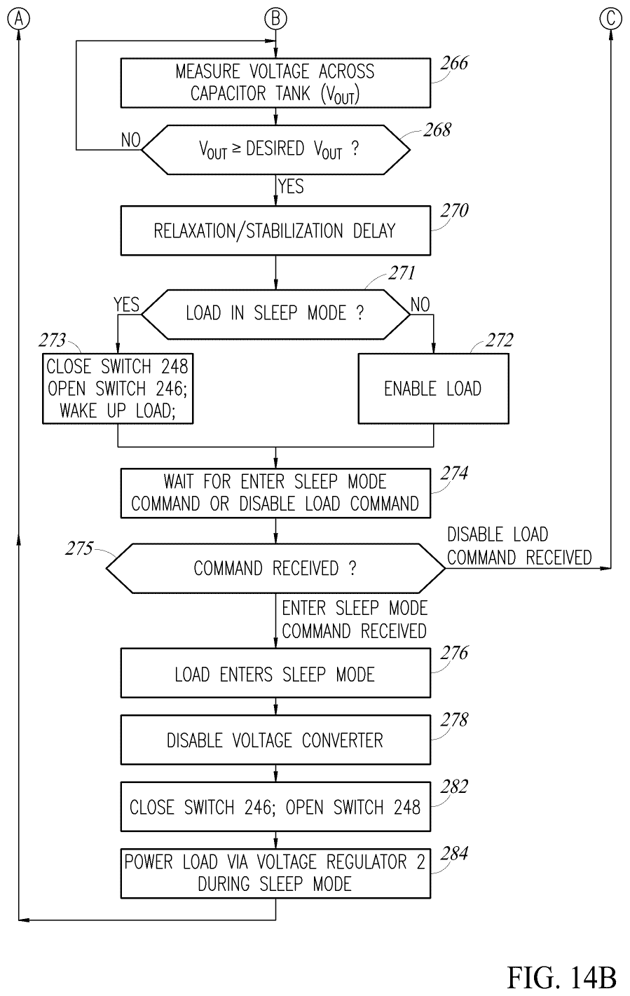

In one embodiment, BPS comprises voltage converter 216, first voltage regulator 1 220, current limiter 218, capacitor tank 222, and control unit 224. The BPS also comprises control signals 230, 234, and 242, and monitoring signals 232 and 236. The BPS may also comprise an optional second voltage regulator 2 226, a first switch 248, and second switch 246. Note that in one embodiment switch 248 incorporates reverse current protection. The control unit may be functionally similar to that of FIG. 11, configured to control the components in the BPS according to programmed instructions, and as required to execute the method described infra in FIGS. 14A and 14B. The BPS also comprises additional control lines 240, 244, and 238.

Note that the optional voltage regulator 2 226 comprises any suitable voltage regulator preferably with low load losses for low load currents to generate a voltage required by the load while in sleep mode. The second voltage regulator is used if the voltage requirements of the load in sleep mode differs from both that of the load in the enabled powered mode and that of the control unit.

Control line 244 is used by the control unit to activate sleep mode in the load and may also be used as a monitoring line to receive a confirmation that the load has entered sleep mode. Control line 240 is used by the control unit to control the operation of switch 248, which is in the closed state when the load is powered on and in the open state when the load is in sleep mode. Control line 238 is used by the control unit to control operation of switch 246, which is in the open state when the load is powered on, and in the closed state when the load is in sleep mode.

A flow diagram illustrating an example BPS method for sleep mode enabled loads, optionally when switching the load between a low powered state (sleep mode), and a powered state, in accordance with an embodiment of the present invention is shown in FIGS. 14A and 14B. In one embodiment, the control unit implements the method when switching an intermittently enabled device between an off state, a low powered state (i.e. sleep mode), and a powered state.

In this embodiment, the BPS method enables the load and then places the load in sleep or low power mode and later wakes the load up, as the cycle continues accordingly. Alternatively, the cycle may start by initially placing the load in sleep or low power mode before waking the load up. Prior to waking the load, the capacitor tank charging process begins until it is fully charged at which time the load is awakened to enable full load operation. Note that the load or BPS may be optionally shut off or disabled completely, returning to the idle state, whereinafter the load may be re-enabled from the idle state in accordance with the method of FIGS. 14A and 14B described supra.

Initially, the BPS is placed in an initial state (step 250). All the components are in a similar state as in steps 42, 180 (FIGS. 3, 12, respectively). Switch 248 is in the closed state and switch 246 is in the open state. Optionally, voltage regulator 2 is powered on. Several subsequent steps are similar to corresponding steps of the method of FIGS. 12A and 12B as described supra and their description will not be repeated.

After placing the BPS in the initial state, the battery voltage is measured (step 251) and once the battery voltage is greater than or equal to the voltage converter minimum input voltage (step 252) the BPS waits to receive either an enable or disable load command (step 253). If a disable load command is received (step 254), the load is disabled (step 289) and the voltage converter is disabled (if enabled) allowing the capacitor tank to discharge (step 290).

If an enable load command is received (step 254), current limit I_{LIMIT1} is then set (step 256) and the voltage converter is enabled (step 258). The voltage across the capacitor tank is measured (step 260) to check whether it has reached the predetermined (or dynamically set) threshold voltage V_{TH} (step 262). Once reached, current limit I_{LIMIT2} is then set (step 264). The voltage across the capacitor tank is measured again (step 266) to check whether it has reached the desired output voltage V_{OUT} (step 268).

Once the desired output voltage has been reached the BPS enters an optional relaxation/stabilization period (step 270), typically in the order of tens or hundreds of milliseconds. This period ‘relaxes’ the ions of the battery electrolyte before the load is enabled which, in combination with the two current spikes and the current decrease between them, the inventors have found significantly extends the life of the battery. Once the relaxation period completes, it is checked whether the load is in sleep mode (step 271). If it is not, the load is enabled since it is already ‘up’ (step 272). If it is not, switch 248 is closed, switch 246 is opened, and the load is woken up (step 273).

Once the load is enabled, it remains in an active powered on state until the control unit receives a command to either place the load in sleep or low power mode or to disable the load completely (step 274). If the disable load command is received, the method of the control unit continues with steps 289 and 290 where the load and the voltage converter are disabled and the capacitor tank is allowed to discharge. If the enter sleep mode command is received, the load enters sleep mode via control line 244 (step 276) and the voltage converter is disabled (step 278). The control unit maintains the states of the control outputs while waiting for the external command to place the load in sleep mode. Note that activating sleep mode in the load may be initiated by transfer of control to a subroutine executable by control unit. The control unit then opens switch 248 via control line 240 disconnecting the capacitor tank from the load and closes switch 246 via control line 238 thereby connecting voltage regulator 2 to the load (step 282). The load is then powered while it is in sleep mode via voltage regulator 2 (226 FIG. 13) (step 284) until it is to be woken up again (step 273) or disabled (step 289).

Note that the control unit may disable the voltage converter (step 278) in response to receiving a sleep acknowledgement signal from the load confirming that the load has successfully entered sleep mode. Alternatively, the control unit may disable the voltage converter after a predetermined period of time following instructing the load to enter sleep mode. In one embodiment, the predetermined period of time is associated with a time delay between receipt of control signal 244 and entering sleep mode.

At some point, the control unit receives a command to enable the load (step 254) and in response initiates the sequence for charging the capacitor tank (as required by the particular implementation) in preparation for waking the load (step 286). Thus, in this manner the wake and sleep cycle repeat.

Note that the method of FIGS. 14A and 14B may be repeated for every operation which requires switching the operation of the load between an unpowered state, sleep mode or low power mode, and a powered state. Note also that one skilled in the art may implement the method using more or less steps and/or a different sequence of steps.

In an alternative embodiment, the capacitor tank may be used to supply power to the load while it is in sleep or low power mode. In this embodiment, the second voltage regulator 236 (FIG. 13) is not required and switch 248 remains closed (or eliminated) while the load is in sleep mode to allow discharge current from the capacitor tank to power the load. The capacitor tank is selected in this case to have sufficient capacitance to power the load for the anticipated duration of time it is to remain in sleep mode which will depend on the particular implementation of the BPS.

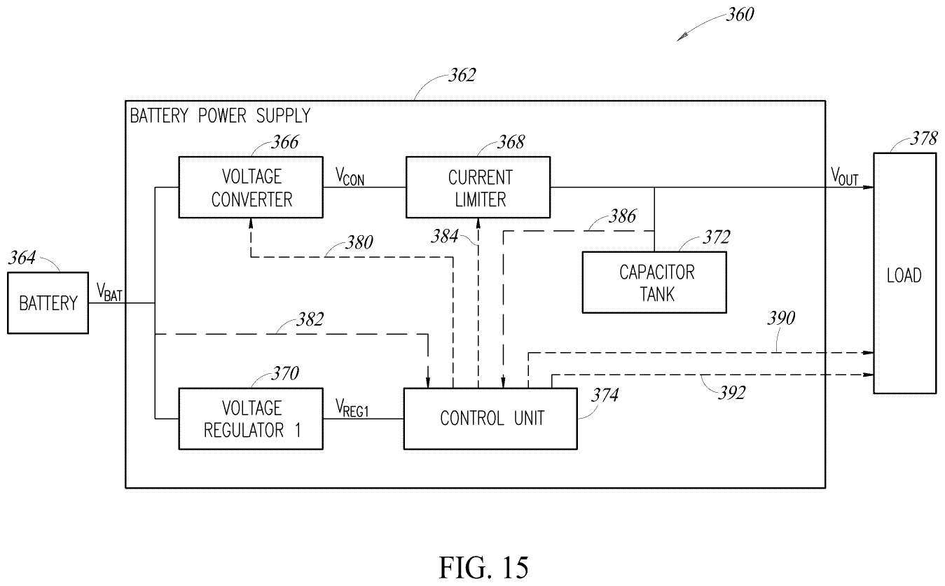

A block diagram illustrating a second example BPS circuit configured for use with intermittently operating devices with a low power mode (i.e. sleep mode), constructed in accordance with an embodiment of the present invention is shown in FIG. 15. The BPS, generally referenced 360, is similar to the BPS 210 (FIG. 13) with the exception of being configured to provide DC power from the capacitor tank 372 to the load 378 where the load is configured to be switched between a high power operational mode and a low power sleep mode, in addition to, or alternative to, an off mode where the load is completely turned off. Note that while the load is in high power operational mode, DC power to the load is provided by the battery 364 and voltage converter 366 as in BPS 210 (FIG. 13).

In one embodiment, the BPS circuit 360 comprises voltage converter 366, voltage regulator 370, current limiter 368, capacitor tank 372, and control unit 374. The BPS also comprises control signals 380, 384, 390, and 392, and monitoring signals 382 and 386. Unlike the circuit of FIG. 13, the BPS 360 does not require a second voltage regulator or a first and second switch. Note that the control unit may be functionally similar to that of FIG. 13, configured to control the components in the BPS according to programmed instructions, and as required to execute a method similar to that described supra in FIGS. 14A and 14B. One difference being in step 284 the load in this embodiment is powered by the capacitor tank while the load is in sleep mode. In addition, step 282 is not required as there are no switches in circuit 360. Control line 392 is used by the control unit to activate sleep mode in the load and may also be used as a monitoring line to receive a confirmation that the load has entered sleep mode.

Additional examples are provided below:

Example 1 pertains to a battery power supply to power an intermittently powered load comprising a voltage downconverter configured to be connected in series to a battery and to output a voltage V_{DC} less than a battery voltage V_{BAT}, a current limiter connected in series to the voltage downconverter and configured to provide a voltage drop when in current limiting mode and to provide a short circuit in a non-current limiting mode, a capacitor tank connected in series to the current limiter for providing a voltage V_{OUT} to the load, and configured to be first charged to a threshold voltage V_{TH} up to 95% of the desired V_{OUT} value while the current limiter is active, and configured to be charged to desired V_{OUT} when the current limiter is shunted, and a controller configured to sense the battery voltage and the voltage of the capacitor tank, and configured to enable and disable the voltage downconverter, and to limit or allow current flow, and to enable and disable the load.

Example 2 includes the subject matter of Example 1 and, optionally, wherein the controller switches the voltage downconverter from the off state to the on state responsive to receiving a signal from a signal source external to the battery power supply.

Example 3 includes the subject matter of example 1 and, optionally, wherein the controller switches the voltage downconverter from the off state to the on state responsive to the battery voltage V_{BAT} being equal to or greater than a minimum required input voltage for the downconverter.

Example 4 includes the subject matter of example 1 and, optionally, wherein the controller switches the current limiting from current limiting mode to shunt mode upon capacitor tank voltage exceeding a threshold voltage, which is up to 95% of the desired V_{OUT}.

Example 5 includes the subject matter of any one or more of the preceding examples and, optionally, wherein the controller activates the load responsive to the capacitor tank being charged to a voltage substantially equal to the desired V_{OUT}.

Example 6 includes the subject matter of example 5 and, optionally, wherein V_{OUT} is held for a period of time at the desired V_{OUT} after the current limiter is shunted and prior to the control unit enabling the load.

Example 7 includes the subject matter of any one or more of the examples 1 to 6 and, optionally, comprising a voltage regulator to supply regulated power to the control unit.

Example 8 includes the subject matter of any one or more of the examples 1 to 7 and, optionally, wherein the battery comprises a non-flat discharge curve and a relatively high internal resistance compared to batteries comprising flat discharge curves.

Example 9 includes the subject matter of any one or more the examples 1 to 8 and, optionally, wherein the battery comprises a flat discharge curve and a relatively low internal resistance.

Example 10 includes the subject matter of any one or more of the examples 1 to 7 and, optionally, wherein the battery comprises one or more alkaline batteries, one or more non-lithium batteries, one or more nickel-metal hydride batteries, one or more lithium batteries, or one or more lithium-ion batteries.

Example 11 includes the subject matter of any one or more of the examples 1 to 8 and, optionally, wherein the battery and/or the load is integrated in the battery power supply.

Example 12 includes the subject matter of any or more of the examples 1 to 11 and, optionally, wherein the intermittently powered load comprises an Internet of Things (IoT) device.

Example 13 includes the subject matter of any one or more of the examples 1 to 12 and, optionally, wherein the control unit is external to the battery power supply.

Example 14 pertains to a method of providing dc power from a battery to an intermittently powered load, the method comprising applying a battery voltage V_{BAT} to a voltage downconverter connected thereto in series, the voltage downconverter configured to output a voltage V_{DC} less than V_{BAT}, applying V_{DC} to a current limiter connected in series to the voltage downconverter, the current limiter configured to provide a voltage drop in a current limiting mode, and to substantially provide a short circuit in a non-current limiting mode, charging a capacitor tank connected in series to the current limiter for providing a voltage V_{OUT} to the load, the capacitor tank configured to be charged to a threshold voltage V_{TH}, which is up to 95% of the desired V_{OUT}, while the current limiter is in a current limiting mode, and configured to be charged to the desired voltage V_{OUT} when the current limiter is shunted, and enabling and disabling the voltage downconverter, and switching the current limiter between a current limiting mode and shunt mode, and to enable and disable the load.

Example 15 includes the subject matter of example 14 and, optionally, switching the voltage downconverter from the off state to the on state responsive to receiving a signal from a signal source external to the battery power supply.

Example 16 includes the subject matter of example 14 and, optionally, switching the voltage downconverter from the off state to the on state responsive to V_{BAT} exceeding a minimum turn-on voltage of the downconverter.

Example 17 includes the subject matter of example 14 and, optionally, switching the current limiter from the current limiting mode to a shunt mode upon sensing the voltage across the capacitor tank exceeds a threshold voltage V_{TH} up to 95% of the desired V_{OUT}.

Example 18 includes the subject matter of any one or more of the examples 14 to 17, and, optionally, measuring V_{BAT}.

Example 19 includes the subject matter of any one or more of the examples 14 to 18 and, optionally, measuring the voltage V_{OUT} on the capacitor tank.

Example 20 includes the subject matter of any one or more of the examples 14 to 19 and, optionally, comprising activating the load responsive to V_{OUT} reaching a desired value.

Example 21 includes the subject matter according to any one or more of the examples 14 to 20, and, optionally, wherein the voltage across the capacitor tank is held for a period of time at a desired output voltage following a period of time after the current limiter is shunted.

Example 22 includes the subject matter of any one or more of the examples 14 to 20 and, optionally, wherein the voltage across the capacitor tank is held for a period of time at a desired output voltage following the current limiter being shunted, prior to the control unit enabling the load.

Example 23 includes the subject matter of any one or more of the examples 14 to 22 and, optionally, wherein the battery comprises a non-flat discharge curve and a relatively high internal resistance compared to batteries comprising flat discharge curves.

Example 24 includes the subject matter of 23 and, optionally, wherein the battery comprises one or more alkaline batteries.

Example 25 includes the subject matter of any one or more of the examples 14 to 22 and, optionally, wherein the battery comprises a flat discharge curve and a relatively low internal resistance.

Example 26 includes the subject matter of example 25 and, optionally, wherein the battery comprises one or more non-lithium, nickel-metal hydride, lithium or lithium-ion batteries.

Example 27 pertains to a device configured to operate intermittently comprising a battery, and a battery power supply comprising a voltage downconverter configured to be connected in series to the battery and to output a voltage V_{DC} less than the battery voltage V_{BAT}, a current limiter connected in series to the voltage downconverter and configured to provide current limiting in a current limiting mode, and to provide shunt in a non-current limiting mode, a capacitor tank connected in series to the current limiter for providing a voltage V_{OUT} to the load and configured to be charged to a voltage up to 95% of a desired V_{OUT}, while the current limiter is switched to the current limiting mode, and configured to be charged to a desired V_{OUT} when the current limiter is shunted, and a controller configured to enable and disable the voltage downconverter, and to switch current limiter between a current limiting mode and a shunt mode, and to switch the load between an off state and an on state.

Example 28 includes the subject matter of example 27 and, optionally, wherein the battery comprises a non-flat discharge curve and a relatively high internal resistance compared to batteries comprising flat discharge curves.

Example 29 includes the subject matter of example 27 and, optionally, wherein the battery comprises a flat discharge curve and a relatively low internal resistance.

Example 30 pertains to a battery power supply to power an intermittently powered load comprising a voltage converter configured to be connected in series to a battery and to output a voltage V_{CON} greater than the voltage requirement of the load, a current limiter connected in series to the voltage converter and configured to be switched between a first lower current limit level and a second higher current limit level, a capacitor tank connected in series to the current limiter for providing V_{OUT} to the load, and configured to be charged to a voltage V_{TH} which is up to 95% of desired V_{OUT} while the current limiter is switched to the first lower current limit level, and further configured to be charged to a voltage V_{CON} when the current limiter is switched to the second higher current limit level, and a controller configured to sense a battery voltage V_{BAT} and the voltage of the capacitor tank, and configured to enable current limiting from the first lower current limit level to the second higher current limit level responsive to sensing that V_{OUT} exceeds V_{TH}. Where applicable, subject matter of Example 30 may optionally combined with any one or more of the examples 1 to 29.

Example 31 includes a battery power supply to power an intermittently operating load including a voltage downconverter configured to be connected in series to a battery and to generate a voltage V_{DC} less than a battery voltage V_{BAT}, a current limiter connected in series to the voltage downconverter and configured to provide a voltage drop in a current limiting mode, and to provide a shunt in a non-current limiting mode, a capacitor tank connected in series to the current limiter for providing voltage V_{OUT} to the load, and configured to be charged to a threshold voltage V_{TH}, which is up to 95% of a desired V_{OUT}, while the current limiter is in the current limiting mode, and configured to be charged to a desired voltage which when the current limiter is shunted, and a controller configured to sense battery voltage and capacitor tank voltage, and configured to enable and disable the voltage downconverter, and to switch the current limiter between current limiting and shunt mode, responsive to intermittent power consumption requirements in the load, and to enable and disable the load.

Example 32 includes the subject matter of Example 31 and, optionally, the controller enables the voltage downconverter responsive to receiving a signal from a signal source external to the battery power supply.

Example 33 includes the subject matter of examples 31 and/or 32 and, optionally, the controller disables the voltage downconverter responsive to the battery voltage being less than a minimum required input for the voltage downconverter.

Example 34 includes the subject matter of any one or more of the examples 31 to 33 and, optionally, the controller switches the current limiter from current limiting to shunt mode upon sensing that the capacitor tank voltage exceeds a threshold voltage V_{TH}, which is up to 95% of a desired V_{OUT}.

Example 35 includes the subject matter of any one or more of the examples 31 to 34 and, optionally, the controller stores V_{OUT} upon sensing that it is less than V_{TH}.

Example 36 includes the subject matter of any one or more of the examples 31 to 35 and, optionally, the controller enables the load responsive to V_{OUT} reaching desired value.

Example 37 includes the subject matter of any one or more of the examples 31 to 36 and, optionally, the voltage across the capacitor tank is maintained at desired V_{OUT} following the current limiter being shunted, prior to the control unit activating the load.

Example 38 includes the subject matter of any one or more of the examples 31 to 37 and, optionally, including a voltage regulator to supply regulated power to the control unit.

Example 39 includes the subject matter of any one or more of the examples 31 to 38 and, optionally, the battery has a non-flat discharge curve and a relatively high internal resistance compared to batteries comprising flat discharge curves.

Example 40 includes the subject matter of any one or more of the examples 31 to 39 and, optionally, the battery includes one or more alkaline batteries.

Example 41 includes the subject matter of any one or more of the examples 31 to 40 and, optionally, the battery includes a flat discharge curve and/or a relatively low internal resistance.

Example 42 includes the subject matter of any one or more of the examples 31 to 41 and, optionally, wherein the battery includes one or more non-lithium, nickel-metal hydride, lithium, or lithium-ion batteries.

Example 43 includes the subject matter of any one or more of the examples 31 to 42 and, optionally, the battery and/or the load is integral to the battery power supply.

Example 44 includes the subject matter of any one or more of the examples 31 to 43 and, optionally, the intermittently powered load includes an IoT device.

Example 45 includes the subject matter of any one or more of the examples 31 to 44 and, optionally, the control unit is external to the battery power supply.

Example 46 concerns a method of providing dc power from a battery to an intermittently operating load, the method including applying a voltage V_{BAT} from a battery to a voltage downconverter connected in series thereto, the voltage downconverter configured to output a voltage V_{DC} less than V_{BAT}, applying V_{DC} to a current limiter connected in series to the voltage downconverter, the current limiter configured to provide current limiting in a current limiting mode and to provide a shunt in a non-current limiting mode, charging a capacitor tank connected in series to the current limiter for providing an output voltage V_{OUT} to the load, the capacitor tank configured to be charged to a threshold voltage V_{TH} which is up to 95% of a desired V_{OUT} while the current limiter is switched to the current limiting mode, and configured to be charged to a desired V_{OUT} when the current limiter is shunted, and sensing V_{BAT} and V_{OUT}, and enabling and disabling the voltage downconverter, and switching the current limiter between current limiting and shunt mode, responsive to intermittent power consumption requirements of the load, and switching the load between an off state and an on state.

Example 47 includes the subject matter of Example 46 and, optionally, switching the voltage downconverter from the off state to the on state responsive to receiving a signal from a source external to the battery power supply.

Example 48 includes the subject matter of any one or more of the examples 46 to 47 and, optionally, switching the voltage downconverter from the off state to the on state responsive to V_{BAT} exceeding a minimum turn-on voltage of the voltage downconverter.

Example 49 includes the subject matter of any one or more of the examples 46 to 48 and, optionally, switching the current limiter from a current limiting mode to a shunt mode upon sensing that V_{OUT} exceeds a threshold voltage which is up to 95% of a desired V_{OUT}.

Example 50 includes the subject matter of any one or more of the examples 46 to 49 and, optionally, measuring V_{BAT}.

Example 51 includes the subject matter of any one or more of the examples 46 to 50 and, optionally, measuring V_{OUT}.

Example 52 includes the subject matter of any one or more of the examples 46 to 51 and, optionally, storing the value of V_{OUT} when it is less than V_{TH}.

Example 53 includes the subject matter of any one or more of the examples 46 to 52 and, optionally, enabling the load in response to V_{OUT} reaching the desired value.

Example 54 includes the subject matter of any one or more of the examples 46 to 53 and, optionally, maintaining V_{OUT} for a period of time (i.e. a relaxation period) at the desired voltage following the current limiter being shunted, prior to the controller enabling the load.

Example 55 includes the subject matter of any one or more of the examples 46 to 54 and, optionally, including regulating the voltage supplied to the control unit.

Example 56 includes the subject matter of any one or more of the examples 46 to 55 and, optionally, the battery has a non-flat discharge curve and a relatively high internal resistance compared to batteries comprising flat discharge curves.

Example 57 includes the subject matter of any one or more of the examples 46 to 56 and, optionally, the battery includes one or more alkaline batteries.

Example 58 includes the subject matter of any one or more of the examples 46 to 57 and, optionally, the battery has a flat discharge curve and/or a relatively low internal resistance.

Example 59 includes the subject matter of any one or more of the examples 46 to 58 and, optionally, the battery includes one or more lithium, lithium-ion, non-lithium or nickel-metal hydride batteries.

Example 60 concerns a device configured to operate intermittently including a battery, and a battery power supply including a voltage downconverter configured to be connected in series to a battery and to generate a voltage V_{DC} less than a battery voltage V_{BAT}, a current limiter connected in series to the voltage downconverter and configured to provide current limiting in a current limiting mode and a short circuit in a non-current limiting mode, a capacitor tank connected in series to the current limiter for providing a voltage V_{OUT} to the load, and configured to be charged to a threshold voltage V_{TH} which is up to 95% of a desired V_{OUT} while the current limiter is in the current limiting mode, and configured to be charged to a desired V_{OUT} when the current limiter is shunted, and a controller configured to switch the voltage downconverter between an off state and an on state, and to switch the current limiter between the current limiting mode and shunt mode, responsive to intermittent power consumption requirements in the load, and to switch the load between an off state and an on state.

Example 61 includes the subject matter of example 60 and, optionally, the device includes an IoT device.

Example 62 includes the subject matter of any one or more of the examples 60 to 61 and, optionally, the battery has a non-flat discharge curve and a relatively high internal resistance compared to batteries comprising flat discharge curves.

Example 63 includes the subject matter of any one or more of the examples 60 to 62 and, optionally, the battery includes one or more alkaline batteries.

Example 64 includes the subject matter of any one or more of the examples 60 to 63 and, optionally, the battery has a flat discharge curve and/or a relatively low internal resistance.

Example 65 includes the subject matter of any one or more of the examples 60 to 64 and, optionally, the battery includes one or more lithium, lithium-ion, nickel-metal hydride or non-lithium batteries.

Example 66 includes a battery power supply to power an intermittently powered load comprising a voltage converter configured to be connected in series to a battery and to output a voltage V_{DC} less than a battery voltage V_{BAT}, a current limiter connected in series to the voltage downconverter and configured to provide a voltage drop when in current limiting mode and to provide a short circuit in a non-current limiting mode, a capacitor tank connected in series to the current limiter for providing a voltage V_{OUT} to the load, and configured to be first charged to a threshold voltage less than the desired V_{OUT} value while the current limiter is active, and configured to be charged to desired V_{OUT} when the current limiter is shunted, and a controller configured to apply a relaxation/stabilization period associated with the battery before the load is enabled, sense the battery voltage and the voltage of the capacitor tank, and configured to enable and disable the voltage downconverter, and to limit or allow current flow, and to enable and disable the load.

Example 67 includes a battery power supply to power an intermittently powered load comprising a buck-boost converter configured to be connected in series to a battery and to output a voltage V_{DC} less than or greater than a battery voltage V_{BAT} using the buck-boost converter, a current limiter connected in series to the converter and configured to provide a voltage drop when in current limiting mode and to provide a short circuit in a non-current limiting mode, a capacitor tank connected in series to the current limiter for providing a voltage V_{OUT} to the load, and configured to be first charged to a threshold voltage less than the desired V_{OUT} value while the current limiter is active, and configured to be charged to desired V_{OUT} when the current limiter is shunted, and a controller configured to sense the battery voltage and the voltage of the capacitor tank, and configured to enable and disable the converter, and to limit or allow current flow, and to enable and disable the load. Note that a relaxation/stabilization period may optionally be applied in this example before the load is enabled.

Example 68 includes a battery power supply to power an intermittently powered load comprising a buck-boost converter configured to be connected in series to a battery and to output a voltage V_{DC} less than or greater than a battery voltage V_{BAT} using the buck-boost converter, a current limiter connected in series to the converter and configured to provide a voltage drop when in current limiting mode and to provide a short circuit in a non-current limiting mode, a capacitor tank connected in series to the current limiter for providing a voltage V_{OUT} to the load, and configured to be first charged to a threshold voltage up to 95% of the desired V_{OUT} value while the current limiter is active, and configured to be charged to desired V_{OUT} when the current limiter is shunted, and a controller configured to sense the battery voltage and the voltage of the capacitor tank, and configured to enable and disable the converter, and to limit or allow current flow, and to enable and disable the load. Note that a relaxation/stabilization period may optionally be applied in this example before the load is enabled.

Example 69 includes a battery power supply operative to power a sleep capable load device and support a low power mode of operation. The BPS comprises a voltage converter configured to be connected in series to a battery and to output a voltage V_{DC} less than a battery voltage V_{BAT}, a current limiter connected in series to the voltage converter and configured to provide a voltage drop when in current limiting mode and to provide a short circuit in a non-current limiting mode, a capacitor tank connected in series to the current limiter for providing a voltage V_{OUT} to the load, and configured to be first charged to a threshold voltage less than the desired V_{OUT} value while the current limiter is active, and configured to be charged to desired V_{OUT} when the current limiter is shunted, and a controller configured to sense the battery voltage and the voltage of the capacitor tank, and configured to enable and disable the voltage converter, and to limit or allow current flow, and to enable and disable the load. In addition, the controller functions to put the load in sleep mode while disabling the voltage converter and using discharge current from the capacitor tank and a voltage regulator to provide power to the load while it is in sleep mode. Note that a relaxation/stabilization period may optionally be applied in this example before the load is woken up and enabled.

Example 70 includes a battery power supply operative to power a sleep capable load device and support a low power mode of operation. The BPS comprises a voltage converter configured to be connected in series to a battery and to output a voltage V_{DC} less than a battery voltage V_{BAT}, a current limiter connected in series to the voltage converter and configured to provide a voltage drop when in current limiting mode and to provide a short circuit in a non-current limiting mode, a capacitor tank connected in series to the current limiter for providing a voltage V_{OUT} to the load, and configured to be first charged to a threshold voltage up to 95% of the desired V_{OUT} value while the current limiter is active, and configured to be charged to desired V_{OUT} when the current limiter is shunted, and a controller configured to sense the battery voltage and the voltage of the capacitor tank, and configured to enable and disable the voltage converter, and to limit or allow current flow, and to enable and disable the load. In addition, the controller functions to put the load in sleep mode while disabling the voltage converter and using discharge current from the capacitor tank and a voltage regulator to provide power to the load while it is in sleep mode. Note that a relaxation/stabilization period may optionally be applied in this example before the load is woken up and enabled.

Example 71 includes a battery power supply operative to power a sleep capable load device and support a low power mode of operation. The BPS comprises a voltage converter configured to be connected in series to a battery and to output a voltage V_{DC} less than a battery voltage V_{BAT}, a current limiter connected in series to the voltage converter and configured to provide a voltage drop when in current limiting mode and to provide a short circuit in a non-current limiting mode, a capacitor tank connected in series to the current limiter for providing a voltage V_{OUT} to the load, and configured to be first charged to a threshold voltage less than the desired V_{OUT} value while the current limiter is active, and configured to be charged to desired V_{OUT} when the current limiter is shunted, and a controller configured to sense the battery voltage and the voltage of the capacitor tank, and configured to enable and disable the voltage converter, and to limit or allow current flow, and to enable and disable the load. In addition, the controller functions to put the load in sleep mode while disabling the voltage converter. Discharge current from the capacitor tank provides sufficient power to the load while it is in sleep mode. Note that a relaxation/stabilization period may optionally be applied in this example before the load is woken up and enabled.

Example 72 includes a battery power supply operative to power a sleep capable load device and support a low power mode of operation. The BPS comprises a voltage converter configured to be connected in series to a battery and to output a voltage V_{DC} less than a battery voltage V_{BAT}, a current limiter connected in series to the voltage converter and configured to provide a voltage drop when in current limiting mode and to provide a short circuit in a non-current limiting mode, a capacitor tank connected in series to the current limiter for providing a voltage V_{OUT} to the load, and configured to be first charged to a threshold voltage up to 95% of the desired V_{OUT} value while the current limiter is active, and configured to be charged to desired V_{OUT} when the current limiter is shunted, and a controller configured to sense the battery voltage and the voltage of the capacitor tank, and configured to enable and disable the voltage converter, and to limit or allow current flow, and to enable and disable the load. In addition, the controller functions to put the load in sleep mode while disabling the voltage converter. Discharge current from the capacitor tank provides sufficient power to the load while it is in sleep mode. Note that a relaxation/stabilization period may optionally be applied in this example before the load is woken up and enabled.

The various features and steps discussed above, as well as other known equivalents for each such feature or step, can be mixed and matched by one of ordinary skill in this art to perform methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

Any digital computer system, module and/or engine exemplified herein can be configured or otherwise programmed to implement a method disclosed herein, and to the extent that the system, module and/or engine is configured to implement such a method, it is within the scope and spirit of the disclosure. Once the system, module and/or engine are programmed to perform particular functions pursuant to computer readable and executable instructions from program software that implements a method disclosed herein, it in effect becomes a special purpose computer particular to embodiments of the method disclosed herein. The methods and/or processes disclosed herein may be implemented as a computer program product that may be tangibly embodied in an information carrier including, for example, in a non-transitory tangible computer-readable and/or non-transitory tangible machine-readable storage device. The computer program product may be directly loadable into an internal memory of a digital computer, comprising software code portions for performing the methods and/or processes as disclosed herein. The term “non-transitory” is used to exclude transitory, propagating signals, but to otherwise include any volatile or non-volatile computer memory technology suitable to the application. Additionally, or alternatively, the methods and/or processes disclosed herein may be implemented as a computer program that may be intangibly embodied by a computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

The terms “non-transitory computer-readable storage device” and “non-transitory machine-readable storage device” encompasses distribution media, intermediate storage media, execution memory of a computer, and any other medium or device capable of storing for later reading by a computer program implementing embodiments of a method disclosed herein. A computer program product can be deployed to be executed on one computer or on multiple computers at one site or distributed across multiple sites and interconnected by one or more communication networks.

These computer readable and executable instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable and executable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable and executable instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended.

Unless otherwise specified, the terms ‘about’ and/or ‘close’ with respect to a magnitude or a numerical value may imply to be within an inclusive range of −10% to +10% of the respective magnitude or value.

It should be noted that where an embodiment refers to a condition of “above a threshold”, this should not be construed as excluding an embodiment referring to a condition of “equal or above a threshold”. Analogously, where an embodiment refers to a condition “below a threshold”, this should not to be construed as excluding an embodiment referring to a condition “equal or below a threshold”. It is clear that should a condition be interpreted as being fulfilled if the value of a given parameter is above a threshold, then the same condition is considered as not being fulfilled if the value of the given parameter is equal or below the given threshold. Conversely, should a condition be interpreted as being fulfilled if the value of a given parameter is equal or above a threshold, then the same condition is considered as not being fulfilled if the value of the given parameter is below (and only below) the given threshold.

It should be understood that where the claims or specification refer to “a” or “an” element and/or feature, such reference is not to be construed as there being only one of that element. Hence, reference to “an element” or “at least one element” for instance may also encompass “one or more elements”.

As used herein the term “configuring” and/or ‘adapting’ for an objective, or a variation thereof, implies using materials and/or components in a manner designed for and/or implemented and/or operable or operative to achieve the objective.

Unless otherwise stated or applicable, the use of the expression “and/or” between the last two members of a list of options for selection indicates that a selection of one or more of the listed options is appropriate and may be made, and may be used interchangeably with the expressions “at least one of the following”, “any one of the following” or “one or more of the following”, followed by a listing of the various options.

As used herein, the phrase “A, B, C, or any combination of the aforesaid” should be interpreted as meaning all of the following: (i) A or B or C or any combination of A, B, and C, (ii) at least one of A, B, and C, and (iii) A, and/or B and/or C. This concept is illustrated for three elements (i.e., A, B, C), but extends to fewer and greater numbers of elements (e.g., A, B, C, D, etc.).

It is noted that the terms “operable to” or “operative to” can encompass the meaning of the term “adapted or configured to”. In other words, a machine “operable to” or “operative to” perform a task can in some embodiments, embrace a mere capability (e.g., “adapted”) to perform the function and, in some other embodiments, a machine that is actually made (e.g., “configured”) to perform the function.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 4, from 1 to 4, from 1 to 5, from 2 to 4, from 2 to 6, from 4 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It should be appreciated that combination of features disclosed in different embodiments are also included within the scope of the present inventions.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A power supply for providing battery based power to an intermittently operating load, comprising:
a voltage converter connected to a battery and operative to generate a desired output voltage;
a current limiter connected in series to said voltage converter and operative to limit the current output thereof;
a capacitor tank electrically connected to said current limiter and to the load;
a controller configured to:
maintain an electrical disconnect between said battery and said capacitor tank when the load is disabled or in sleep mode by disabling said voltage converter via a first control signal thereby preventing battery discharge due to capacitor tank parasitic self-discharge;
enable said voltage converter before the load is to be enabled or woken up whereby said capacitor tank is charged through said current limiter in a controlled manner in accordance with a first charge current surge profile to a threshold voltage less than 95% of the desired output voltage;
remove current limiting via a second control signal when the voltage on the capacitor tank reaches the threshold voltage, to immediately further charge said capacitor tank to the desired output voltage in accordance with a second charge current surge profile;
enable the load via a third control signal only after the second charge current surge profile is complete;
disable said voltage converter when the load is to be disabled or placed in sleep mode thereby disconnecting said battery from said capacitor tank to prevent battery discharge; and
wherein the threshold voltage, characteristics of the first charge current surge profile and that of the second charge current surge profile are configured to aid in maximizing both battery capacity utilization and battery life.

2. The power supply according to claim 1, further comprising the controller configured to power the load from said capacitor tank while the load is in sleep mode.

3. The power supply according to claim 1, wherein the battery comprises one or more alkaline batteries, lithium batteries, lithium-ion batteries, non-lithium batteries or nickel-metal hydride batteries.

4. The power supply according to claim 1, wherein said voltage converter comprises at least one of a DC/DC converter, voltage downconverter, voltage upconverter, or a buck-boost converter.

5. The power supply according to claim 1, wherein said current limiter comprises a plurality of current limiting levels, each level comprising either fixed or continuously variable current limiting capability, each level corresponding to a different charge current surge profile.

6. The power supply according to claim 1, wherein said capacitor tank comprises a single capacitor or a plurality of capacitors connected in parallel.

7. The power supply according to claim 1, further comprising a voltage regulator to supply regulated power to the controller.

8. The power supply according to claim 1, wherein the controller periodically measures battery voltage and/or voltage across said capacitor tank.

9. A power supply for providing battery based power to an intermittently operating load, comprising:
a voltage converter connected to a battery and operative to generate a desired output voltage;
a current limiter connected in series to said voltage converter and operative to limit the current output thereof;
a capacitor tank electrically connected to said current limiter and to the load;
a controller configured to:
maintain an electrical disconnect between said battery and said capacitor tank when the load is disabled or in sleep mode by disabling said voltage converter via a first control signal thereby preventing battery discharge due to capacitor tank parasitic self-discharge;
enable said voltage converter before the load is to be enabled or woken up whereby said capacitor tank is charged through said current limiter in a controlled manner in accordance with a first charge current surge profile to a threshold voltage less than the desired output voltage;
remove current limiting via a second control signal when the voltage on the capacitor tank reaches the threshold voltage, to immediately further charge said capacitor tank to the desired output voltage in accordance with a second charge current surge profile;
enable the load via a third control signal after waiting a period of time after current limiting is removed corresponding to a relaxation period associated with the battery;
disable said voltage converter when the load is to be disabled or placed in sleep mode thereby disconnecting said battery from said capacitor tank to prevent battery discharge; and
wherein the threshold voltage, characteristics of the first charge current surge profile and that of the second charge current surge profile are configured to aid in maximizing both battery capacity utilization and battery life.

10. The power supply according to claim 9, further comprising the controller configured to power the load from said capacitor tank while the load is in sleep mode.

11. The power supply according to claim 9, wherein the battery comprises one or more alkaline batteries, lithium batteries, lithium-ion batteries, non-lithium batteries or nickel-metal hydride batteries.

12. The power supply according to claim 9, wherein said voltage converter comprises at least one of a DC/DC converter, voltage downconverter, voltage upconverter or a buck-boost converter.

13. The power supply according to claim 9, wherein said current limiter comprises a plurality of current limiting levels, each level comprising either fixed or continuously variable current limiting capability, each level corresponding to a different charge current surge profile.

14. The power supply according to claim 9, wherein said capacitor tank comprises a single capacitor or a plurality of capacitors connected in parallel.

15. The power supply according to claim 9, further comprising a voltage regulator to supply regulated power to the controller.

16. The power supply according to claim 9, wherein the controller periodically measures battery voltage and/or voltage across said capacitor tank.

17. A power supply for providing battery based power to an intermittently operating load, comprising:
a voltage converter connected to a battery and operative to generate a desired output voltage;
a first voltage regulator having an input connected to said battery and an output connected via a switch to said load;
a current limiter connected in series to said voltage converter and operative to limit the current output thereof;
a capacitor tank electrically connected to said current limiter and to the load;
a controller configured to:
maintain an electrical disconnect between said battery and said capacitor tank when the load is disabled or in sleep mode by disabling said voltage converter via a first control signal thereby preventing battery discharge due to capacitor tank parasitic self-discharge;
power the load from said first voltage regulator while the load is disabled or in sleep mode;
enable said voltage converter before the load is to be enabled or woken up whereby said voltage converter charges said capacitor tank via said current limiter, said capacitor tank charged to a threshold voltage less than 95% of the desired output voltage;
remove current limiting via a second control signal when the voltage on the capacitor tank reaches the threshold voltage, to immediately further charge said capacitor tank to the desired output voltage;
enable the load via a third control signal after said capacitor tank is charged to the desired output voltage;
disable said voltage converter when the load is to be disabled or placed in sleep mode thereby disconnecting said battery from said capacitor tank to prevent battery discharge; and
wherein the threshold voltage is configured to aid in maximizing both battery capacity utilization and battery life.

18. The power supply according to claim 17, wherein the battery comprises one or more alkaline batteries, lithium batteries, lithium-ion batteries, non-lithium batteries or nickel-metal hydride batteries.

19. The power supply according to claim 17, wherein said voltage converter comprises at least one of a DC/DC converter, voltage downconverter, voltage upconverter or a buck-boost converter.

20. The power supply according to claim 17, wherein said current limiter comprises a plurality of current limiting levels, each level comprising either fixed or continuously variable current limiting capability, each level corresponding to a different charge current surge profile.

21. The power supply according to claim 17, wherein said capacitor tank comprises a single capacitor or a plurality of capacitors connected in parallel.

22. The power supply according to claim 17, further comprising a second voltage regulator to supply regulated power to the controller.

23. The power supply according to claim 17, wherein the controller periodically measures battery voltage and/or voltage across said capacitor tank.

24. A power supply for providing battery based power to an intermittently operating load, comprising:
a voltage converter connected to a battery and operative to generate a desired output voltage;
a first voltage regulator having an input connected to said battery and an output connected via a switch to said load;
a current limiter connected in series to said voltage converter and operative to limit the current output thereof;
a capacitor tank electrically connected to said current limiter and to the load;
a controller configured to:
maintain an electrical disconnect between said battery and said capacitor tank when the load is disabled or in sleep mode by disabling said voltage converter via a first control signal thereby preventing battery discharge due to capacitor tank parasitic self-discharge;
power the load from said first voltage regulator while the load is disabled or in sleep mode;
enable said voltage converter before the load is to be enabled or woken up whereby said voltage converter charges said capacitor tank via said current limiter, said capacitor tank charged to a threshold voltage less than the desired output voltage;
remove current limiting via a second control signal when the voltage on the capacitor tank reaches the threshold voltage, to immediately further charge said capacitor tank to the desired output voltage;
enable the load via a third control signal after waiting a period of time after current limiting is removed corresponding to a relaxation period associated with the battery;
disable said voltage converter when the load is to be disabled or placed in sleep mode thereby disconnecting said battery from said capacitor tank to prevent battery discharge; and
wherein the threshold voltage is configured to aid in maximizing both battery capacity utilization and battery life.

25. The power supply according to claim 24, wherein the battery comprises one or more alkaline batteries, lithium batteries, lithium-ion batteries, non-lithium batteries or nickel-metal hydride batteries.

26. The power supply according to claim 24, wherein said voltage converter comprises at least one of a DC/DC converter, voltage downconverter, voltage upconverter or a buck-boost converter.

27. The power supply according to claim 24, wherein said current limiter comprises a plurality of current limiting levels, each level comprising either fixed or continuously variable current limiting capability, each level corresponding to a different charge current surge profile.

28. The power supply according to claim 24, wherein said capacitor tank comprises a single capacitor or a plurality of capacitors connected in parallel.

29. The power supply according to claim 24, further comprising a second voltage regulator to supply regulated power to the controller.

30. The power supply according to claim 24, wherein the controller periodically measures battery voltage and/or voltage across said capacitor tank.

31. A method of providing power to an intermittently operating load in a battery power supply including a voltage converter, current limiter, capacitor tank, and controller, the method comprising:
electrically disconnecting the battery from said capacitor tank while the load is disabled or in sleep mode by disabling the voltage converter thereby preventing battery discharge due to capacitor tank parasitic self-discharge current;
enabling said voltage converter before the load is to be enabled or woken up whereby said voltage converter charges said capacitor tank via said current limiter, said capacitor tank charged to a threshold voltage less than 95% of a desired output voltage;
removing current limiting when the voltage on the capacitor tank reaches the threshold voltage, to immediately further charge said capacitor tank to the desired output voltage;
enabling the load after the capacitor tank is charged to the desired output voltage; and
wherein the threshold voltage is configured to aid in maximizing battery capacity utilization and battery life.

32. The method according to claim 31, further comprising providing power to the load via said capacitor tank while the load is in sleep mode.

33. The method according to claim 31, wherein the battery comprises one or more alkaline batteries, lithium batteries, lithium-ion batteries, non-lithium batteries or nickel-metal hydride batteries.

34. The method according to claim 31, wherein said voltage converter comprises at least one of a DC/DC converter, voltage downconverter, voltage upconverter or a buck-boost converter.

35. The method according to claim 31, wherein said current limiter comprises a plurality of current limiting levels, each level comprising either fixed or continuously variable current limiting capability, each level corresponding to a different charge current surge profile.

36. The method according to claim 31, wherein said capacitor tank comprises a single capacitor or a plurality of capacitors connected in parallel.

37. The method according to claim 31, further comprising providing regulated power to the controller via a voltage regulator.

38. The method according to claim 31, further comprising periodically measuring battery voltage and/or voltage across said capacitor tank.

39. A method of providing power to an intermittently operating load in a battery power supply including a voltage converter, current limiter, capacitor tank, and controller, the method comprising:
electrically disconnecting the battery from said capacitor tank while the load is disabled or in sleep mode by disabling the voltage converter thereby preventing battery discharge due to capacitor tank parasitic self-discharge current;
enabling said voltage converter before the load is to be enabled or woken up whereby said voltage converter charges said capacitor tank via said current limiter, said capacitor tank charged to a threshold voltage less than a desired output voltage;
removing current limiting when the voltage on the capacitor tank reaches the threshold voltage, to immediately further charge said capacitor tank to the desired output voltage;
enabling the load after waiting a period of time after current limiting is removed corresponding to a relaxation period associated with the battery; and
wherein the threshold voltage is configured to aid in maximizing battery capacity utilization and battery life.

40. The method according to claim 39, further comprising providing power to the load via said capacitor tank while the load is in sleep mode.

41. The method according to claim 39, wherein the battery comprises one or more alkaline batteries, lithium batteries, lithium-ion batteries, non-lithium batteries or nickel-metal hydride batteries.

42. The method according to claim 39, wherein said voltage converter comprises at least one of a DC/DC converter, voltage downconverter, voltage upconverter or a buck-boost converter.

43. The method according to claim 39, wherein said current limiter comprises a plurality of current limiting levels, each level comprising either fixed or continuously variable current limiting capability, each level corresponding to a different charge current surge profile.

44. The method according to claim 39, wherein said capacitor tank comprises a single capacitor or a plurality of capacitors connected in parallel.

45. The method according to claim 39, further comprising providing regulated power to the controller via a voltage regulator.

46. The method according to claim 39, further comprising periodically measuring battery voltage and/or voltage across said capacitor tank.

47. A power supply for providing battery based power to an intermittently operating load, comprising:
a voltage converter connected to a battery and operative to generate a desired output voltage;
a current limiter connected in series to said voltage converter and operative to limit the current output thereof;
a capacitor tank electrically connected to said current limiter and to the load;
a controller configured to enable said voltage converter before the load is to be enabled or woken up whereby said capacitor tank is charged through said current limiter in accordance with a first charge current surge profile to a threshold voltage less than 95% of the desired output voltage; and
wherein the threshold voltage is configured to aid in maximizing both battery capacity utilization and battery life.

48. The power supply according to claim 47, wherein said controller is further configured to maintain an electrical disconnect between said battery and said capacitor tank when the load is disabled or in sleep mode by disabling said voltage converter via a first control signal thereby preventing battery discharge due to capacitor tank parasitic self-discharge.

49. The power supply according to claim 47, wherein said controller is further configured to remove current limiting via a second control signal when the voltage on the capacitor tank reaches the threshold voltage, to immediately further charge said capacitor tank to the desired output voltage in accordance with a second charge current surge profile.

50. The power supply according to claim 47, wherein said controller is further configured to enable the load via a third control signal only after the second charge current surge profile is complete.

51. The power supply according to claim 47, wherein said controller is further configured to disable said voltage converter when the load is to be disabled or placed in sleep mode thereby disconnecting said battery from said capacitor tank to prevent battery discharge.

52. The power supply according to claim 47, further comprising the controller configured to power the load from said capacitor tank while the load is in sleep mode.

53. The power supply according to claim 47, wherein the battery comprises one or more alkaline batteries, lithium batteries, lithium-ion batteries, non-lithium batteries or nickel-metal hydride batteries.

54. The power supply according to claim 47, wherein said voltage converter comprises at least one of a DC/DC converter, voltage downconverter, voltage upconverter, or a buck-boost converter.

55. The power supply according to claim 47, wherein said current limiter comprises a plurality of current limiting levels, each level comprising either fixed or continuously variable current limiting capability, each level corresponding to a different charge current surge profile.

56. The power supply according to claim 47, wherein said capacitor tank comprises a single capacitor or a plurality of capacitors connected in parallel.

57. The power supply according to claim 47, further comprising a voltage regulator to supply regulated power to the controller.

58. The power supply according to claim 47, wherein the controller periodically measures battery voltage and/or voltage across said capacitor tank.

59. A power supply for providing battery based power to an intermittently operating load, comprising:
a voltage converter connected to a battery and operative to generate a desired output voltage;
a current limiter connected in series to said voltage converter and operative to limit the current output thereof;
a capacitor tank electrically connected to said current limiter and to the load;
a controller configured to enable said voltage converter before the load is to be enabled or woken up whereby said capacitor tank is charged through said current limiter in a controlled manner in accordance with a first charge current surge profile to a threshold voltage less than the desired output voltage, and to enable the load after waiting a period of time after current limiting is removed corresponding to a relaxation period associated with the battery; and
wherein the threshold voltage is configured to aid in maximizing both battery capacity utilization and battery life.

60. The power supply according to claim 59, wherein the controller is further configured to maintain an electrical disconnect between said battery and said capacitor tank when the load is disabled or in sleep mode by disabling said voltage converter thereby preventing battery discharge due to capacitor tank parasitic self-discharge.

61. The power supply according to claim 59, wherein the controller is further configured to remove current limiting when the voltage on the capacitor tank reaches the threshold voltage, to immediately further charge said capacitor tank to the desired output voltage in accordance with a second charge current surge profile.

62. The power supply according to claim 59, wherein the controller is further configured to disable said voltage converter when the load is to be disabled or placed in sleep mode thereby disconnecting said battery from said capacitor tank to prevent battery discharge.

63. The power supply according to claim 59, further comprising the controller configured to power the load from said capacitor tank while the load is in sleep mode.

64. The power supply according to claim 59, wherein the battery comprises one or more alkaline batteries, lithium batteries, lithium-ion batteries, non-lithium batteries or nickel-metal hydride batteries.

65. The power supply according to claim 59, wherein said voltage converter comprises at least one of a DC/DC converter, voltage downconverter, voltage upconverter or a buck-boost converter.

66. The power supply according to claim 59, wherein said current limiter comprises a plurality of current limiting levels, each level comprising either fixed or continuously variable current limiting capability, each level corresponding to a different charge current surge profile.

67. The power supply according to claim 59, wherein said capacitor tank comprises a single capacitor or a plurality of capacitors connected in parallel.

68. The power supply according to claim 59, further comprising a voltage regulator to supply regulated power to the controller.

69. The power supply according to claim 59, wherein the controller periodically measures battery voltage and/or voltage across said capacitor tank.
